(19) United States
(12) Patent Application Publication
(10) Pub. No.: US 2006/0024624 A1
(43) Pub. Date: Feb. 2, 2006

(54) Heat-developable color light-sensitive material

(75) Inventors: Tetsu Kamosaki, Minami-ashigara-shi (JP); Yasuhiro Ishiwata, Minami-ashigara-shi (JP); Takehiko Satou, Minami-ashigara-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-ashigara-shi (JP)

(21) Appl. No.: 11/190,925

(22) Filed: Jul. 28, 2005

(30) Foreign Application Priority Data
Jul. 30, 2004 (JP) 2004-224541

(51) Int. Cl. G03C 7/32

(52) U.S. Cl. 430/543

(57) ABSTRACT

A heat-developable color light-sensitive material containing light-sensitive silver halide grains, a binder, at least one compound of formula (I), and at least one dye-providing compound of formula (II), on a support, wherein at least one of layers containing the light-sensitive silver halide grains contains the binder, the compound of formula (I), and the dye-providing compound of formula (II) and,
wherein the heat-developable color light-sensitive material contains no compound that participates in a coupling reaction with an oxidized product of the compound of formula (I): Formula (I) 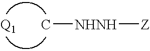
wherein Z represents a carbamoyl, acyl, alkoxycarbonyl, aryloxycarbonyl, sulfonyl, or sulfamoyl group; and Q₁ represents a group of atoms necessary to form an unsaturated ring; Formula (II) 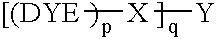 wherein DYE represents a dye or dye precursor group; Y represents a specific group; X represents a simple bond or a connecting group; p denotes 1 or more, and q denotes 1 or 2.

### FIELD OF THE INVENTION

The present invention relates to a heat-developable color light-sensitive material, and particularly to a heat-developable color light-sensitive material that is improved in developing temperature dependency and has a good print white background.

### BACKGROUND OF THE INVENTION

Heretofore, processes for forming an image by heat developing a silver halide photographic light-sensitive material are well known, as described in, for example, the publication of U.S. Pat. No. 4,500,626.

Also, a photographic method using heat-developable light-sensitive materials using a silver halide has been widely practiced, because the method is superior in photographic characteristics, such as sensitivity and gradation, to such methods as an electronic photographic method and a diazo photographic method. Many methods have been proposed to obtain a color image by heat development using a silver halide light-sensitive material. One of these methods is a color-developing system in which a dye image is formed by a coupling reaction between an oxidized product of a developing agent and a coupler. As to the developing agent and coupler in this color-developing system, a combination of a sulfonamidophenol-type reducing agent and a tetraequivalent coupler is proposed in the publication of U.S. Pat. No. 4,021,240.

This method, however, has drawbacks, such as the color development of undeveloped parts, due to printout of undeveloped silver halide left after the treatment, or deterioration with time, and color impurity, due to both reduced silver and a color image being simultaneously present at the exposed portion. As such, a dye transfer system, in which a diffusible dye is formed by heat development, to transfer it to an image-receiving layer, is proposed to solve these drawbacks.

Regarding such a diffusion transfer-type, heat-developable, light-sensitive material, there are a case in which a light-sensitive material and an image-receiving layer, capable of receiving a dye, are formed on the same support, and a case in which an image-receiving layer is formed on a support separately from a light-sensitive material.

Particularly, when such a light-sensitive material is used as a heat-developable color light-sensitive material, it is desirable to use an image-receiving material provided with a dye image-receiving layer formed on a separate support, and to diffuse and transfer a dye to the image-receiving material at the same time that, or after, a diffusible dye is formed by color development, in order to obtain a dye image having high color purity.

Methods are proposed in which diffusible dyes are released or formed image-wise by heat development and then the diffusible dyes are transferred to a dye-fixing element. In this method, a negative dye image and a positive dye image can both be obtained by changing the type of dye-providing compound and the type of silver halide to be used. These methods have a problem that the sensitivity of the light-sensitive material is reduced, because a color-developed dye is fixed to a dye-providing substance in advance. It is therefore desirable to realize a system in which a coupler that is colorless at the first is reacted with a developing agent, to diffuse a target dye.

On the other hand, as means of forming a diffusible dye to form an image by the coupling system, heat-developable light-sensitive materials containing a coupler and a color-developing agent precursor capable of releasing a p-phenylenediamine are disclosed, for example, in JP-A-6-83005 (“JP-A” means unexamined published Japanese patent application); a combination of a ureidoanilin-series reducing agent with an active methylene-type coupler is disclosed in JP-A-59-111148; and light-sensitive materials, wherein use is made of a coupler that has a split-off group with a polymer chain and that can release a diffusible dye by color development, are disclosed in JP-A-58-149047; a technique wherein, with a combination of a carbamoylhydrazine-series developing agent and an active methylene-type coupler, a diffusible dye is formed and released, is disclosed in JP-A-09-152705.

However, among the image-forming methods described in these documents, particularly the image-forming method using a dye-providing substance has problems, such as a large developing temperature dependency, and such a drawback leads to deterioration in the image quality of a print image. Moreover, various compounds have been used to improve the developing temperature dependency. However, there are, for example, such problems as that the white background (Dmin) of a print is impaired. There has been, therefore, a need for establishment of technologies to improve both the developing temperature dependency and white background.

### SUMMARY OF THE INVENTION

The present invention is a heat-developable color light-sensitive material comprising light-sensitive silver halide grains, a binder, at least one compound represented by formula (I), and at least one dye-providing compound represented by formula (II), on a support, wherein at least one of layers containing the light-sensitive silver halide grains contains the binder, the compound of formula (I), and the dye-providing compound of formula (II), at the same time, and wherein the heat-developable color light-sensitive material contains no compound that participates in a coupling reaction with an oxidized product of the compound of formula (I): 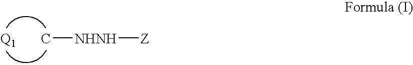
wherein, in formula (I), Z represents a carbamoyl group, an acyl group, an alkoxycarbonyl group, an aryloxycarbonyl group, a sulfonyl group, or a sulfamoyl group; and Q₁ represents a group of atoms necessary to form an unsaturated ring together with the carbon atom that bonds with —NHNH-Z;

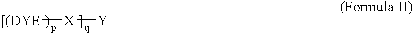

wherein, in formula (II), DYE represents a dye group or a dye precursor group; Y represents a group that makes a difference for the diffusibility of the dye component corresponding to the reduction of the light-sensitive silver halide having an image-wise latent image to silver; X represents a simple bond or a connecting group; p denotes a natural number of 1 or more, and q denotes 1 or 2, where DYEs may be the same or different when p is 2 or more and [(DYE)ₚ-X]s may be the same or different when q is 2.

Other and further features and advantages of the invention will appear more fully from the following description.

### DETAILED DESCRIPTION OF THE INVENTION

The present inventors, having made earnest studies to solve the above problem, have found that a compound represented by formula (I) improves developing temperature dependency and is converted into an oxidized product as a dye during heat development, and the oxidized product is transferred to an image-receiving material, with the result that a good white background is obtained. The present invention was thus attained based on this finding. Accordingly, the present invention relates to:

(1) A heat-developable color light-sensitive material comprising light-sensitive silver halide grains, a binder, at least one compound represented by formula (I), and at least one dye-providing compound represented by formula (II), on a support,

wherein at least one of layers containing the light-sensitive silver halide grains contains the binder, the compound of formula (I), and the dye-providing compound of formula (II), at the same time, and

wherein the heat-developable color light-sensitive material contains no compound that participates in a coupling reaction with an oxidized product of the compound of formula (I):

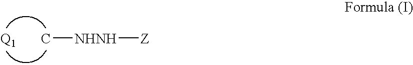

wherein, in formula (I), Z represents a carbamoyl group, an acyl group, an alkoxycarbonyl group, an aryloxycarbonyl group, a sulfonyl group, or a sulfamoyl group; and Q₁ represents a group of atoms necessary to form an unsaturated ring together with the carbon atom that bonds with —NHNH-Z;

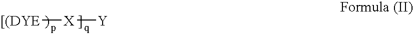

wherein, in formula (II), DYE represents a dye group or a dye precursor group; Y represents a group that makes a difference for the diffusibility of the dye component corresponding to the reduction of the light-sensitive silver halide having an image-wise latent image to silver; X represents a simple bond or a connecting group; p denotes a natural number of 1 or more, and q denotes 1 or 2, where DYEs may be the same or different when p is 2 or more and [(DYE)ₚ-X]s may be the same or different when q is 2.

(2) The heat-developable color light-sensitive material according to the above (1),

which contains a basic metal compound that is scarcely soluble in water, and

which forms an image by a reaction with an image-receiving material,

wherein the image-receiving material contains a mordant, and a compound that is capable of forming a complex with a metal ion constituting the basic metal compound in the presence of water in an amount of 1/10 to 1 times the amount necessary to give a fully swollen heat-developable color light-sensitive material, and

wherein, in the reaction, the heat-developable color-light-sensitive material and the image-receiving material are overlapped on each other, and heated in the overlapped state at a film surface temperature of from 50° C. to 100° C., for from 1 second to 120 seconds, to form or release a diffusible dye, and the diffusible dye is then diffused to the image-receiving material, to react with the mordant.

The details of the present invention will be explained hereinbelow.

First, the compound represented by formula (I) for use in the present invention will be explained. The details of the compound represented by formula (I) are described JP-A-9-152705.

In formula (I), Z represents a carbamoyl group, an acyl group, an alkoxycarbonyl group, an aryloxycarbonyl group, a sulfonyl group, or a sulfamoyl group. Among these groups, a carbamoyl group is preferable, and a carbamoyl group having a hydrogen atom bonded on the nitrogen atom is particularly preferable.

The carbamoyl group represented by Z is preferably a carbamoyl group having 1 to 50 carbon atoms and more preferably 2 to 40 carbon atoms.

The acyl group represented by Z is preferably an acyl group having 1 to 50 carbon atoms and more preferably 6 to 40 carbon atoms.

The alkoxycarbonyl group represented by Z is preferably an alkoxycarbonyl group having generally 2 to 50 carbon atoms and preferably 6 to 40 carbon atoms. The aryloxycarbonyl group represented by Z is preferably an aryloxycarbonyl group having 7 to 50 carbon atoms and preferably 7 to 40 carbon atoms.

The sulfamoyl group represented by Z is preferably a sulfamoyl group having 1 to 50 carbon atoms and more preferably 2 to 40 carbon atoms.

Q₁ represents a group of atoms necessary to form an unsaturated ring together with the carbon atom that bonds with —NHNH-Z. The unsaturated ring formed is preferably a 3 to 8-membered ring, and more preferably a 5- to 6-membered ring. Preferable examples of the unsaturated ring include benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isooxazole ring, and thiophene ring. Condensed rings obtained by condensing these rings with each other are also preferable.

These rings may have one or more substituents, and the substituent may further have another substituent.

The number of carbon atoms of the substituent is preferably 50 or less, more preferably 42 or less, and most preferably 30 or less.

As to the substituent on the ring constituted of Q₁ and C bonded with —NHNH-Z, when the ring is formed only of carbon atoms (e.g., a benzene ring, naphthalene ring, and anthracene ring), the sum total of the Hammett's substituent constant σ values of substituents on the ring (σp value is used when the substituent has 1,2, 1,4, . . . , or 1,2n (n=1, 2, 3, . . . ) relation to the C, and σm value is used when the substituent has 1,3, 1,5, . . . , or 1,2n+1 (n=1, 2, 3, . . . ) relation to the C) is generally 0.8 or more, preferably 1.2 or more, and most preferably 1.5 or more.

Herein, Hammett's substituent constants op and cym are described in detail in such books as “Hammett Soku-Kozo to Hannousei-,” written by Naoki Inamoto (Maruzen); “Shinjikken Kagaku-koza 14/Yukikagoubutsu no Gosei to Hanno V,” page 2605 (edited by Nihonkagakukai, Manizen); “Riron Yukikagaku Kaisetsu,” written by Tadao Nakaya, page 217 (Tokyo Kagakudojin); and “Chemical Review” (Vol. 91), pages 165 to 195 (1991).

The amount of the compound of formula (I) is generally about 0.001 to 100 mmol/m², preferably 0.01 to 10 mmol/m², and more preferably 0.05 to 5.0 mmol/m² per unit area of light-sensitive material.

The compound of formula (I) is preferably added to a layer containing light-sensitive silver halide grains, a dye-providing compound of formula (II), and a binder at the same time. However, if there is at least one layer containing the compound of formula (I), the light-sensitive silver halide grains, the dye-providing compound of formula (II), and the binder at the same time, other layers may contain the compound of formula (I) singly, or in combination with the light-sensitive silver halide grains or with the dye-providing compound of formula (II).

Specific examples of the compound represented by formula (I) that are preferably used in the present invention are shown below, but the compound represented by formula (I) is not limited by these examples.

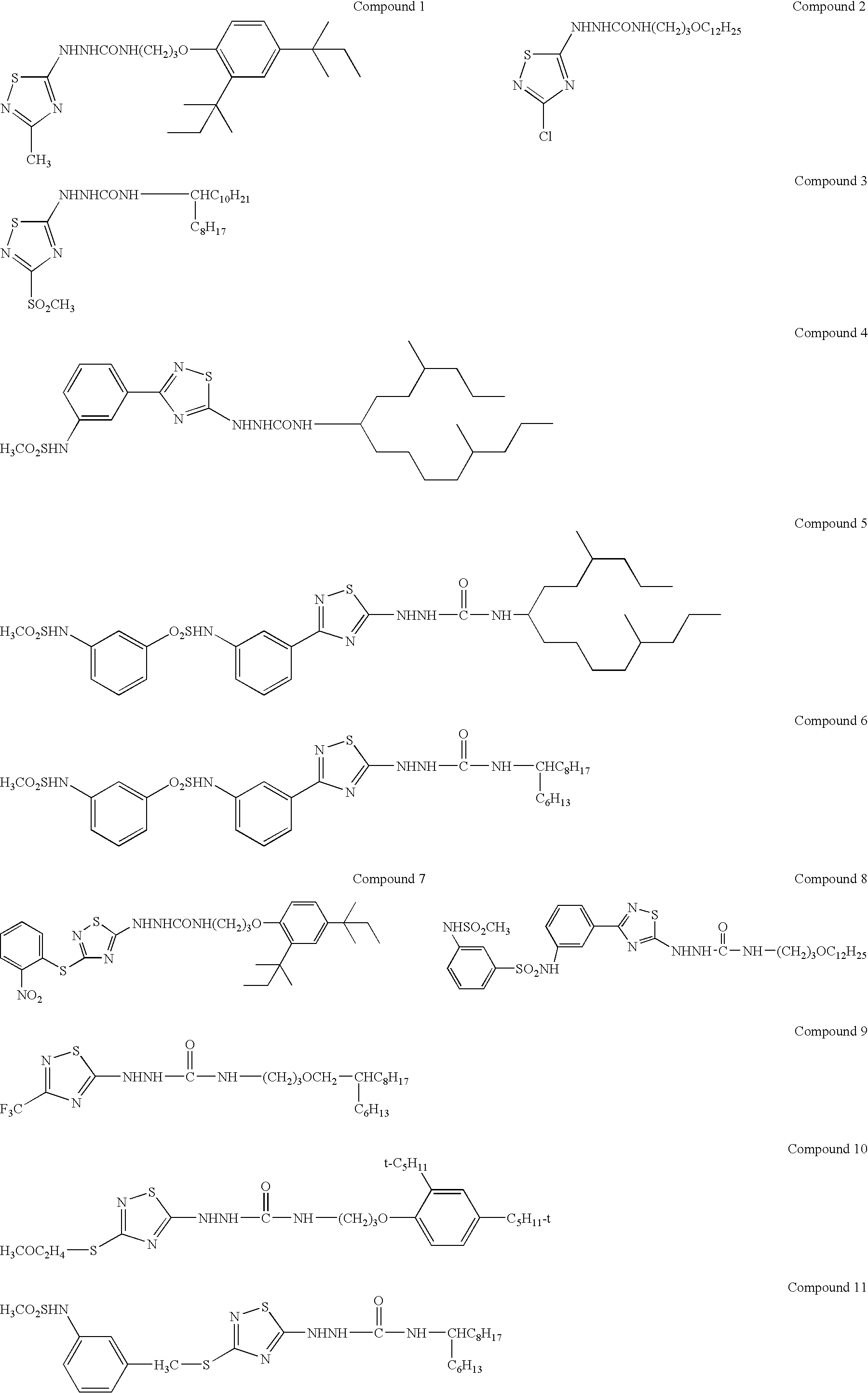

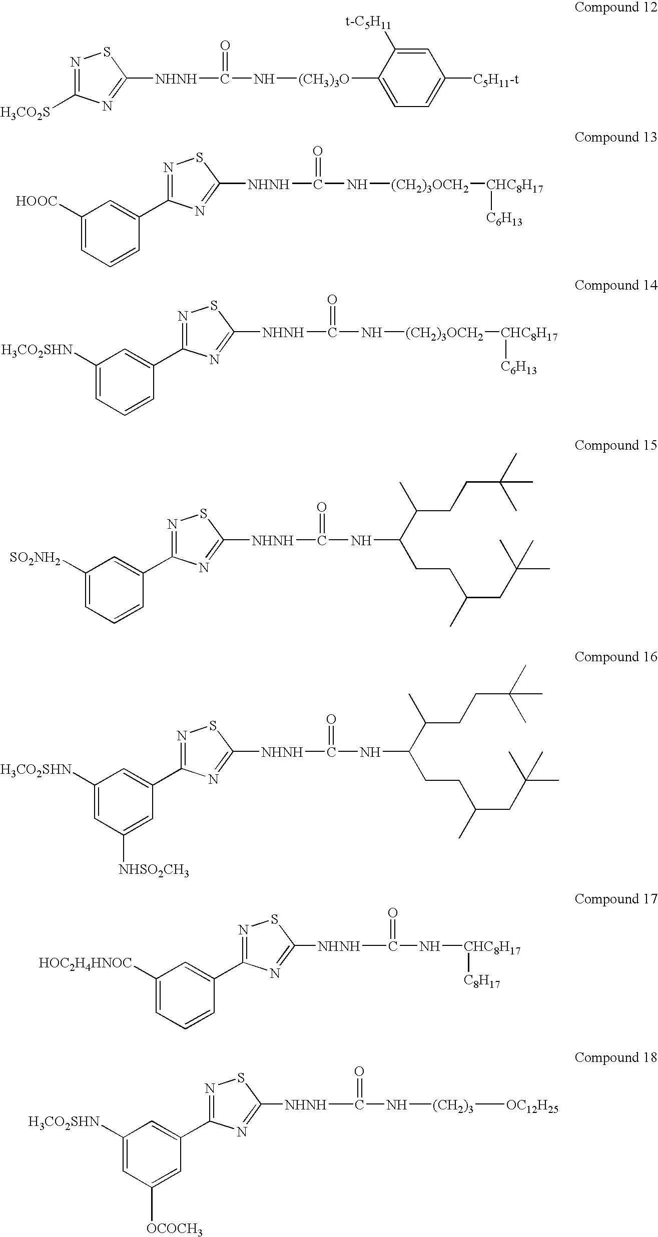

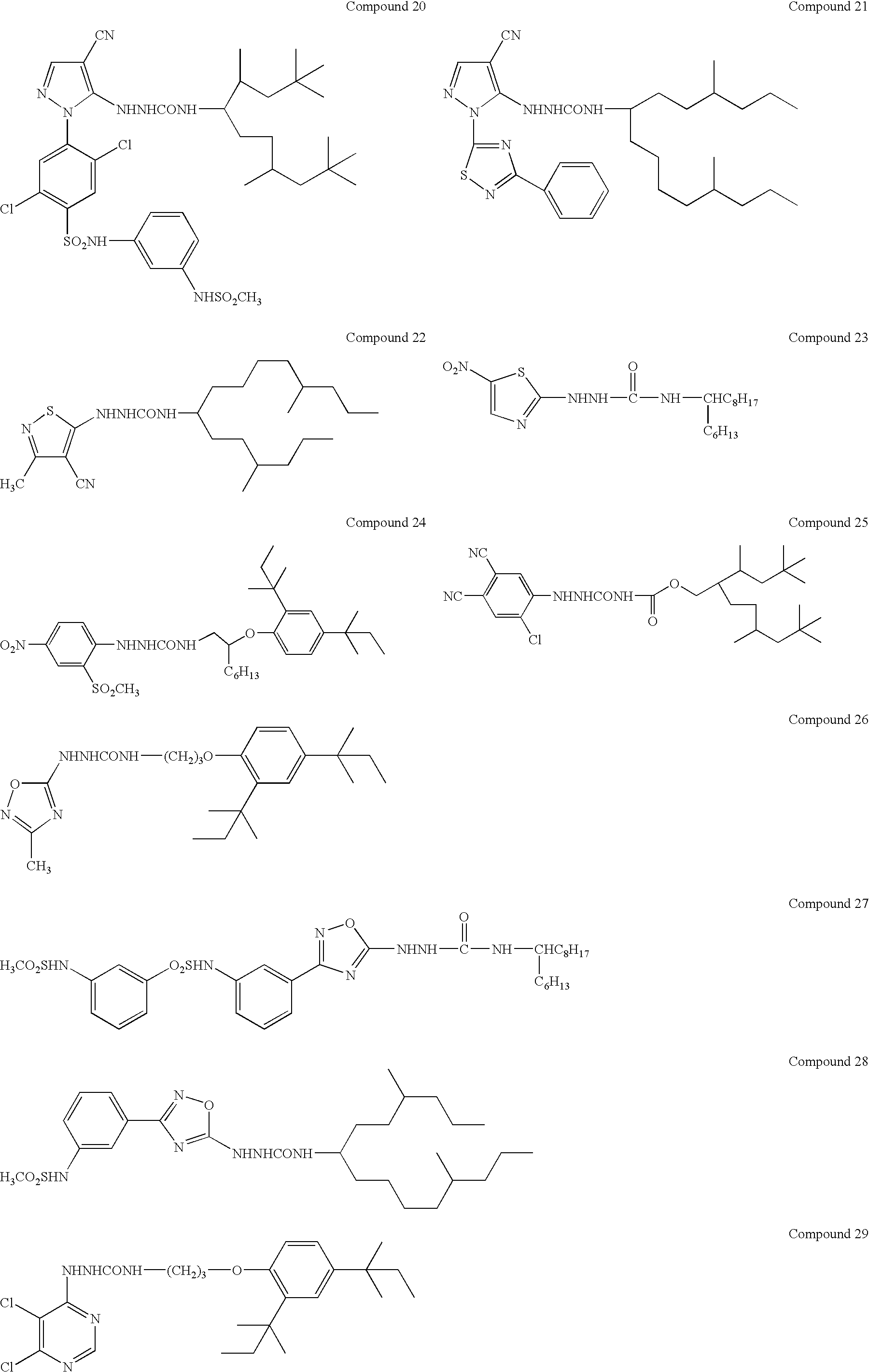

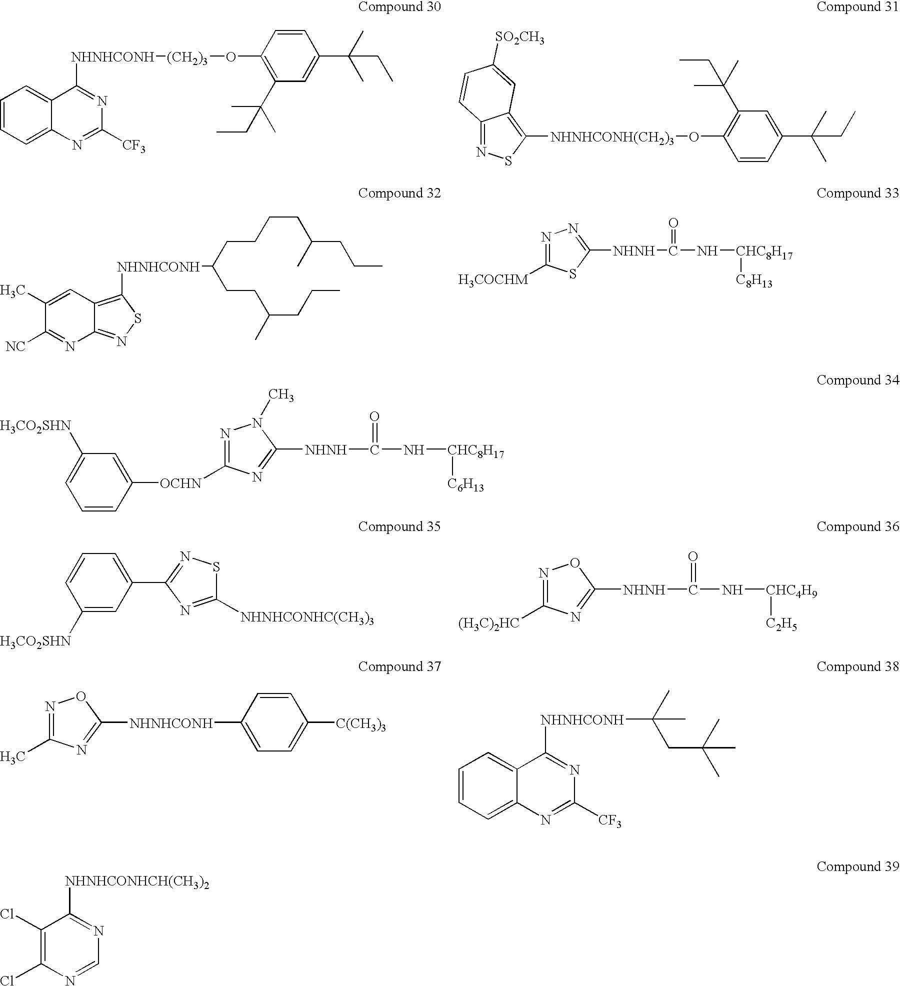

Besides the aforementioned specific compounds, carbamoylhydrazine type compounds as described in each specification of JP-A-8-286340, JP-A-9-152700, JP-A-9-152701, JP-A-9-152702, JP-A-9-152703, JP-A-9-152704, JP-A-9-152705, JP-A-9-211818, JP-A-11-125887, JP-A-2000-098561, JP-A-2000-284438, JP-A-2000-284439, JP-A-2000-284443, JP-A-2001-013647, and JP-A-2002-107888 are useful as the compounds represented by formula (I). The compounds represented by formula (I) according to the present invention may be synthesized by the methods described in the aforementioned patent publications that disclose the carbamoylhydrazine compounds.

The compound of formula (I) is contained in at least one of the layers containing the silver halide grains, in coexistence with the dye-providing compound of formula (II). The compound of formula (I) is generally used in a coating amount of 0.1 to 2000 mg and preferably 1 to 1000 mg per m².

Examples of a method of adding the compound of formula (I) include a method in which the compound of formula (I) is dissolved in a high-boiling solvent or an organic solvent and emulsion-dispersed in a water-soluble binder, such as a gelatin, and the resulting dispersion is then added; a method in which the compound of formula (I) is dissolved in an organic solvent or water, to add the compound in the form of a solution; and a method in which the compound of formula (I) is added in a form of solid dispersion.

The functions of the compound of formula (I) will be explained.

The compound of formula (I) is a hydrazine that is a reducing agent. It is possible to improve developing activity and developing temperature dependency, by adding the compound of formula (I). Moreover, the compound of formula (I) has the characteristics that after it is converted into an oxidized product in the heat development treatment, the oxidized product is converted into a diffusible compound. Further, the oxidized product is converted into a dye having yellow to magenta color. It has been discovered that when a heat development is conducted by overlapping a heat-developable light-sensitive material on an image-receiving material, the oxidized product converted into a dye is transferred to the image-receiving material, and good white background is obtained as a result. The present invention has been made with focused on the effect of improving the developing temperature dependency and on the function as a white background controlling agent.

It is necessary for the heat-developable color light-sensitive material of the present invention not to include a compound (coupler) that undergoes a coupling reaction with an oxidized product of the compound of formula (I). Specific examples of the coupler are described in detail, for example, in “Theory of The Photographic Process” (4th Ed., edited by T. H. James, Macmillan, 1977), pages 291 to 334 and 354 to 361, and in JP-A-58-12353, JP-A-58-149046, JP-A-58-149047, JP-A-59-11114, JP-A-59-124399, JP-A-59-174835, JP-A-59-231539, JP-A-59-231540, JP-A-60-2951, JP-A-60-14242, JP-A-60-23474, and JP-A-60-66249.

Particularly, the heat-developable color light-sensitive material of the present invention does not contain compounds that are collectively called as active methylenes, pyrazolones, pyrazoloazoles, phenols, naphthols or pyrrolotriazoles, as described in JP-A-9-152705 and the like.

In addition to the above, couplers having a structure such as condensed-ring phenol, imidazole, pyrrole, 3-hydroxypyridine, active methylene, active methine, 5,5-condensed-ring heterocycle or 5,6-condensed-ring heterocycle are not used in the heat-developable color light-sensitive material.

In the present invention, in addition to the above couplers, use cannot be made of couplers described, for example, in West Germany Patent Nos. 3,819,051A and 3,823,049, U.S. Pat. Nos. 4,840,883, 5,024,930, 5,051,347, and 4,481,268, European Patent Nos. 304,856A2, 329,036, 354,549A2, 374,781A2, 379,110A2, and 386,930A1, and JP-A-63-141055, JP-A-64-32260, JP-A-64-32261, JP-A-2-297547, JP-A-2-44340, JP-A-2-110555, JP-A-3-7938, JP-A-3-160440, JP-A-3-172839, JP-A-4-172447, JP-A-4-179949, JP-A-4-182645, JP-A-4-184437, JP-A-4-188138, JP-A-4-188139, JP-A-4-194847, JP-A-4-204532, JP-A-4-204731, and JP-A-4-204732.

Next, the dye-providing compound represented by formula (II) will be explained.

The definition “a group that makes a difference for the diffusibility of the dye component corresponding to the reduction of the light-sensitive silver halide having an image-wise latent image to silver” refers to both the embodiments wherein the diffusibility of the dye component changes corresponding to the degree of the development (reduction) of a silver halide and wherein the diffusibility of the dye component changes corresponding reversely to the degree of the development (reduction) of a silver halide.

As specific examples of the dye-providing compound represented by formula (II), the following compounds <1> to <4> may be given, wherein the following compounds <1> to <3> are those which release a diffusible dye to form an image (positive dye image) corresponding inversely to the development of a silver halide, and the compounds <4> are those which release a diffusible dye to form an image (negative dye image) corresponding to the development of a silver halide.

<1> Dye developing agents obtained by combining a hydroquinone-series developing agent with a dye component, as described, for example, in U.S. Pat. No. 3,134,764, No. 3,362,819, No. 3,597,200, No. 3,544,545 and No. 3,482,972. These dye developing agent are those which are diffusible under an alkaline atmosphere but become non-diffusible when they are reacted with a silver halide.

<2> Non-diffusible compounds which release a diffusible dye under an alkaline atmosphere but lose the ability when they are reacted with a silver halide, may also be used, as described in U.S. Pat. No. 4,503,137, and the like. Examples thereof include compounds which release a diffusible dye by an intramolecular nucleophilic substitution reaction, as described in U.S. Pat. No. 3,980,479 and the like, and compounds which release a diffusible dye by an intramolecular reversion reaction of an isoxazolone ring, as described in U.S. Pat. No. 4,199,354 and the like.

<3> Non-difflusible compounds which react with a reducing agent that is remained non-oxidized by development, to thereby release a diffusible dye, as described, for example, in U.S. Pat. No. 4,559,290, European Patent No. 220,746(A2), U.S. Pat. No. 4,783,396 and Kokai-Giho 87-6199, may also be used. Examples thereof include compounds which release a diffusible dye by an intramolecular nucleophilic substitution reaction after being reduced, as described, for example, in U.S. Pat. No. 4,139,389 and No. 4,139,379, JP-A-59-185333 and JP-A-57-84453; compounds which release a diffusible dye by an intramolecular electron-transfer reaction after being reduced, as described, for example, in U.S. Pat. No. 4,232,107, JP-A-59-101649, JP-A-61-88257 and RD24025 (1984); compounds which release a diffusible dye by the cleavage of a single bond after being reduced, as described, for example, in West German Patent No. 3,008,588A, JP-A-56-142530, U.S. Pat. No. 4,343,893 and No. 4,619,884; nitro compounds which release a diffusible dye after the receipt of electrons, as described in U.S. Pat. No. 4,450,223 and the like; and compounds which release a diffusible dye after the receipt of electrons, as described in U.S. Pat. No. 4,609,610. More preferable examples include compounds having an N—X bond (X represents an oxygen, sulfur, or nitrogen atom) and an electron-attractive group in one molecule, as described, for example, in European Patent No. 220,746 (A2), Kokai-Giho 87-6199, JP-A-63-201653 and JP-A-63-201654; compounds having SO₂—X (X has the same meaning as defined above) and an electron-attractive group in one molecule, as described in JP-A-1-26842; compounds having a PO—X bond (X has the same meaning as defined above) and an electron-attractive group in one molecule, as described in JP-A-63-271344; and compounds having a C—X′ bond (X′ has the same meaning as X, or X′ represents —SO₂—) and an electron-attractive group in one molecule, as described in JP-A-63-271341. Among these compounds, compounds having an N—X bond and an electron-attractive group in one molecule are preferable in particular. Specific examples of the preferable compounds include the compounds (1) to (3), (7) to (10), (12), (13), (15), (23) to (26), (31), (32), (35), (36), (40), (41), (44), (53) to (59), (64), and (70) described in U.S. Pat. No. 4,783,396 or European Patent No. 220,746 (A2), and the compounds (11) to (23) described in Kokai-Giho 87-6199.

<4> Compounds (DRR compounds) which can reduce a silver halide or an organic silver salt and release a diffusible dye when they reduce a counter compound. Because this compound requires no other reducing agent, it is free from such a problem of contamination to an image which contamination is caused by an oxidation decomposed product of the reducing agent, and it is therefore preferable. Specific examples thereof are described, for example, in U.S. Pat. No. 3,928,312, No. 4,053,312, No. 4,055,428 and No. 4,336,322, JP-A-59-65839, JP-A-59-69839, JP-A-53-3819, JP-A-51-104343, RD17465, U.S. Pat. No. 3,725,062, No. 3,728,113 and No. 3,443,939, JP-A-58-116537, JP-A-57-179840 and U.S. Pat. No. 4,500,626. Specific examples of the DRR compound may include compounds described in the aforementioned U.S. Pat. No. 4,500,626, columns 22 to 44. Among these compounds, compounds (1) to (3), (10) to (13), (16) to (19), (28) to (30), (33) to (35), (38) to (40) and (42) to (64), as described in the above U.S. Patent, are preferable. The compounds described in U.S. Pat. No. 4,639,408, columns 37 to 39 are also useful.

In the invention according to the above item (2), the formation of an image in the heat-developable color light-sensitive material utilizes the generation of a base at the time of developing. However, if any component put into a base form is contained in the heat-developable color light-sensitive material or in the image-receiving material which is to be applied to the heat-developable color light-sensitive material at the time of developing treatment, problems such as fogging occur while the material is being stored. In order to solve this problem, it is effective that a basic metal compound scarcely soluble in water be contained in one of the heat-developable color light-sensitive material and the image-receiving material, and a compound (complexing agent) capable of complexation reaction with the metal ion constituting the basic metal compound in the presence of water as a medium be contained in the other material. As a combination of the basic metal compound which is scarcely soluble in water and is used as a basic precursor and the compound (complexing agent) capable of complexation reaction with the metal ion constituting the basic metal compound in the presence of water as a medium, those described in, for example, each publication of JP-A-62-129848 and European Patent No. 210660A2 may be used.

When the heat-developable color light-sensitive material containing such a basic precursor and the image-receiving material, as mentioned above, are used to form an image, it is effective to use water in an image forming process involving the generation of a base, the developing step, and the subsequent releasing of a dye, transfer of the dye to the image-receiving material and mordanting. The amount of water is preferably 1 to 1/10 times the amount necessary to give a fully swollen heat-developable color light-sensitive material. When the amount of water is too small, the heat-developable color light-sensitive material is insufficiently swollen and an image forming reaction does not proceed. When the amount of water is too much, this gives rise to such problems that the concentration of a base is reduced so that the progress of the image forming reaction is decelerated or that the heat-developable color light-sensitive material and the image-receiving material which are applied to each other are slipped off each other, causing image bleeding.

Next, other compounds that can be used in the heat-developable color light-sensitive material of the present invention will be explained.

The silver halide emulsion will be hereinafter explained in detail. The silver halide emulsion that can be used in the present invention may comprise any one of silver chloride, silver bromide, silver iodobromide, silver chlorobromide, silver chloroiodide, and silver chloroiodobromide.

The silver halide emulsion that can be used in the present invention may be a surface latent image type emulsion. Also, the silver halide emulsion may be the so-called core/shell emulsion having different phases in the inside and surface layers of an individual grain. Silver halides having different compositions may be conjugated by epitaxial junction. The silver halide emulsion may be a monodisperse or a polydisperse; and a method in which monodisperse emulsions are mixed to regulate the gradation, as described in JP-A-1-167743 and JP-A-4-223463, is preferably used. The size of the grain is preferably 0.2 μm or less.

As to the crystal habit of the silver halide grain, any of the followings: silver halide grains having a regular crystal form, such as a cubic, octahedron, or tetradecahedron; silver halide grains having an irregular crystal system, such as a spherical or tabular grain having a high aspect ratio; silver halide grains having crystal defects, such as a twin plane; or complex systems of these crystals, is allowed.

In the process for preparing the light-sensitive silver halide emulsion that can be used in the present invention, so-called desalting, for removing excess salts, is preferably carried out. As a means for attaining it, the noodle water-washing method, which is carried out with the gelatin gelled, can be used, and also the sedimentation method, in which inorganic salts comprising polyvalent anions (e.g. sodium sulfate), an anionic surfactant, an anionic polymer (e.g. polystyrenesulfonic acid sodium salt), or a gelatin derivative (e.g. an aliphatic-acylated gelatin, an aromatic-acylated gelatin, and an aromatic-carbamoylated gelatin) is employed, can be used, with the sedimentation method being preferred.

The light-sensitive silver halide emulsion that can be used in the present invention may contain a heavy metal, such as iridium, rhodium, platinum, cadmium, zinc, thallium, lead, iron, and osmium, to achieve various purposes. These compounds may be used either singly or in combination of two or more. The amount to be added varies depending on the purpose of the application; but the amount is generally on the order of 10⁻⁹ to 10⁻³ mol, per mol of the silver halide. When they are incorporated, they may be incorporated uniformly in the grains, or they may be localized in the grains or on the surface of the grains. Specifically, the emulsions described, for example, in JP-A-2-236542, JP-A-1-116637, and JP-A-5-181246 are preferably used.

In the step for forming grains of the light-sensitive silver halide emulsion, as a silver halide solvent, use can be made of, for example, a rhodanate, ammonia, a tetrasubstituted thioether compound, an organic thioether derivative described in JP-B-47-11386, or a sulfur-containing compound described in JP-A-53-144319.

As other conditions employed to prepare the emulsion in the present invention, the description, for example, by P. Glafkides in “Chemie et Phisique Photographique,” Paul Montel, 1967; by G. F. Duffin in “Photographic Emulsion Chemistry,” Focal Press, 1966; or by V. L. Zelikman et al. in “Making and Coating Photographic Emulsion,” Focal Press, 1964, can be referred to. That is, any of the acid process, the neutral process, and the ammonia process can be used; and as a method to react a soluble silver salt with a soluble halogen salt, any of the single-jet method, the double-jet method, and a combination thereof can be used. To obtain a monodispersed emulsion, the double-jet method is preferably used. A method wherein grains are formed in the presence of excess silver ions (the so-called reverse precipitation process) can also be used. As one type of the double-jet method, a method wherein pAg in the liquid phase, in which a silver halide will be formed, is kept constant, that is, the so-called controlled double-jet method, can also be used.

Further, to quicken the growth of the grains, the concentrations, the amounts, and the addition speeds of the silver salt and the halide to be added may be increased (e.g. JP-A-55-142329, JP-A-55-158124, and U.S. Pat. No. 3,650,757). As the method of stirring the reaction liquid, any of known stirring methods may be used. The temperature and the pH of the reaction liquid during the formation of the silver halide grains may be set arbitrarily to meet the purpose. Preferably the pH range is 2.3 to 8.5, and more preferably 2.5 to 7.5.

The light-sensitive silver halide emulsion is generally a chemically-sensitized silver halide emulsion.

To chemically sensitize the light-sensitive silver halide emulsion, known sensitization methods for silver halide emulsions in ordinary light-sensitive materials, for example, a chalcogen sensitization method, such as a sulfur sensitization method, a selenium sensitization method, and a tellurium sensitization method; a noble metal sensitization method, wherein a noble metal, such as gold, platinum, or palladium, is used; and a reduction sensitization method, can be used alone or in combination (e.g. JP-A-3-110555 and JP-A-5-241267). These chemical sensitizations can be carried out in the presence of a nitrogen-containing heterocyclic compound (JP-A-62-253159). Further, an antifoggant can be added after the completion of chemical sensitization. Specifically, methods described in JP-A-5-45833 and JP-A-62-40446 can be used. It is preferable that an antifoggant be added after completion of chemical sensitization.

At the time of chemical sensitization, the pH is preferably 5.3 to 10.5, and more preferably 5.5 to 8.5, and the pAg is preferably 6.0 to 10.5, and more preferably 6.8 to 9.0. The coating amount of the light-sensitive silver halide that can be used in the present invention is preferably in the range of 1 mg/m² to 10 g/m² in terms of silver, and more preferably in the range of 10 mg/m² to 10 g/m².

When a light-sensitive silver halide for use in the present invention is made to have color sensitivities of green sensitivity, red sensitivity, or infrared sensitivity, the light-sensitive silver halide emulsion is spectrally sensitized with methine dyes or the like. If required, a blue-sensitive emulsion may be spectrally sensitized in the blue region.

Dyes that can be used include cyanine dyes, merocyanine dyes, composite cyanine dyes, composite merocyanine dyes, holopolar cyanine dyes, hemicyanine dyes, styryl dyes, and hemioxonol dyes. Specifically, sensitizing dyes described, for example, in U.S. Pat. No. 4,617,257, JP-A-59-180550, JP-A-64-13546, JP-A-5-45828, and JP-A-5-45834 can be mentioned. These sensitizing dyes can be used singly or in combination thereof, and a combination of these sensitizing dyes is often used, particularly for the purpose of adjusting the wavelength of spectral sensitivity, and for the purpose of supersensitization.

Together with the sensitizing dye, a dye having no spectral sensitizing action itself, or a compound that does not substantially absorb visible light and that exhibits supersensitization, may be included in the emulsion (e.g. those described, for example, in U.S. Pat. No. 3,615,641 and JP-A63-23145). The time when these sensitizing dyes are added to the emulsion may be at a time of chemical ripening or before or after chemical ripening. Further, the sensitizing dyes may be added before or after the formation of nuclei of the silver halide grains, in accordance with U.S. Pat. No. 4,183,756 and U.S. Pat. No. 4,225,666. Further, these sensitizing dyes and supersensitizers may be added in the form of a solution in an organic solvent, such as methanol, or in the form of a dispersion in gelatin or the like, or in the form of a solution in a surface-active agent. Generally the amount of the sensitizing dye to be added is of the order of 10⁻⁸ to 10⁻² mol per mol of silver halide.

Hydrophobic additives, such as a dye-providing compound, a nondiffusible reducing agent, and the like, can be introduced into a layer of the light-sensitive material, by using a known method described in U.S. Pat. No. 2,322,027, and the like. In this case, a high-boiling organic solvent, as described in JP-A-59-83154, JP-A-59-178451, JP-A-59-178452, JP-A-59-178453, JP-A-59-178454, JP-A-59-178455, JP-A-59-178457, and the like, may be used in combination with a low-boiling organic solvent having a boiling point of 50 to 160° C., according to the need. The amount of the high-boiling organic solvent is generally 10 g or less, and preferably 5 g or less, per 1 g of the dye-providing compound to be used. Also, it is proper to use the high-boiling organic solvent in an amount of generally 1 ml or less, preferably 0.5 ml or less, and particularly preferably 0.3 ml or less, per 1 g of binder.

A dispersing method that uses a polymer as described in JP-B-51-39853 and JP-A-51-59943 can be also employed. In the case of a compound that is substantially insoluble in water, other than the above methods, a method can be used wherein the compound is dispersed and contained in the form of a fine particle in a binder. When the hydrophobic compound is dispersed in a hydrophilic colloid, various surfactants may be used. For example, those listed as examples of the surfactant in JP-A-59-157636, page (37) to page (38) may be used.

The light-sensitive material of the present invention basically comprises a light-sensitive silver halide (emulsion), a hydrophilic binder, and a dye-providing compound being capable of releasing a diffusible dye corresponding to silver development, on a support, and the light-sensitive material may further contain an organic metal salt oxidant, and the like, according to the need. These components are added to the same one layer in many cases, but they may be divided and added separately to different layers as far as they are in a reactive state. In the heat-developable light-sensitive material of the present invention, the constitutions other than the aforementioned points may be accorded with the known ones.

In order to obtain a wide range color within the chromaticity diagram by using three primary colors of yellow, magenta, and cyan, a combination of at least three silver halide emulsion layers having sensitivity to different spectrum ranges is used. In the present invention, a combination of three layers, specifically, a blue-sensitive layer, a green-sensitive layer, and a red-sensitive layer may be generally adopted. These light-sensitive layers may be arranged in the various orders known in the usual type color light-sensitive materials. Also, each of these light-sensitive layers may be divided into two or more layers according to the need.

In a color-image forming method by the subtractive color process which has been usually used, in particular, a silver halide emulsion (blue-sensitive emulsion) having a spectral sensitivity in a wavelength range from 400 nm to 500 nm is contained in a light-sensitive layer containing a yellow-dye-providing compound (a color-image forming substance), a silver halide emulsion (green-sensitive emulsion) spectrally sensitized in a wavelength range from 500 nm to 600 nm is contained in a light-sensitive layer containing a magenta-dye-providing compound (a color-image forming substance), and a silver halide emulsion (red-sensitive emulsion) spectrally sensitized in a wavelength range from 600 nm to 740 nm is contained in a light-sensitive layer containing a cyan-dye-providing compound (a color-image forming substance). Also, in this case, the yellow-light-sensitive layer is preferably the outermost layer most apart from the support among the light-sensitive layers, since it is colored in a yellow color. Specifically, this implies a combination of a red-sensitive layer containing a cyan-dye-providing compound, an intermediate layer, a green-sensitive layer containing a magenta-dye-providing compound, an intermediate layer, a blue-sensitive layer containing a yellow-dye-providing compound, an intermediate layer, and a protective layer, which are arranged in this order from the support.

Almost the same characteristics are obtained even if the cyan layer and the magenta layer are arranged in reverse order. Also, each light-sensitive layer may be formed of two layers, each of the two layers may contain a dye-providing compound and a silver halide emulsion, alternatively a silver halide emulsion may be contained only in the upper layer of the two layers and a dye-providing compound may be contained also in the lower layer of the two layers to thereby attain higher sensitization. Also, a light-sensitive material, in which at least one visible-light-sensitive layer is replaced by an infrared-light-sensitive layer having a maximum spectral light-sensitivity in a wavelength region of 750 nm or more, is also preferred.

In the heat-developable color light-sensitive material, various auxiliary layers, such as a protective layer, an undercoat layer, an intermediate layer, a yellow filter layer, an antihalation layer, and a backing layer, may be provided. When the support is made of polyethylene laminate paper containing a white pigment such as titanium oxide, the backing layer is preferably designed to have antistatic ability and a surface resistivity of 10¹² Ω·cm or less.

In addition to the compound represented by formula (I), a reducing agent can be used in the light-sensitive material of the present invention (hereinafter referred to as a second reducing agent). As the second reducing agent that can be used in the light-sensitive material of the present invention, those known in the fields of light-sensitive materials may be used. Also, dye-providing compounds having reducibility, which are described in detail later, are also included in the examples of the second reducing agent (in this case, another reducing agent may be used together). A reducing agent precursor which has no reducibility per se, and which develops reducibility by the effect of a nucleophilic reagent or heat in a development step, may also be used as the second reducing agent.

Examples of the second reducing agent that can be used in the light-sensitive material of the present invention include reducing agents and reducing agent precursors, as described, for example, in U.S. Pat. No. 4,500,626, columns 49 to 50; No. 4,483,914, columns 30 to 31; No. 4,330,617, and No. 4,590,152, JP-A-60-140335, pp. 17-18; JP-A-57-40245, JP-A-56-138736, JP-A-59-178458, JP-A-59-53831, JP-A-59-182449, JP-A-59-182450, JP-A-60-119555, JP-A-60-128436, JP-A-60-128437, JP-A-60-128438, JP-A-60-128439, JP-A-60-198540, JP-A-60-181742, JP-A-61-259253, JP-A-62-244044, JP-A-62-131253, JP-A-62-131254, JP-A-62-131255, JP-A-62-131256, and European Patent No. 220,746(A2), pp. 78-96. Combinations of various reducing agents, as disclosed in U.S. Pat. No. 3,039,869, may also be used.

When a non-diffusive reducing agent is used as the second reducing agent, in combination therewith, an electron-transfer agent and/or an electron-transfer precursor may be used, according to the need, to promote electron transportation between the non-diffusive reducing agent and a developable silver halide. The electron transfer agent or its precursor can be selected from the aforementioned second reducing agents and their precursors. It is preferable that the electron transfer agents or their precursors have a higher mobility than the non-diffusive reducing agent (electron donator). Particularly useful electron transfer agents are 1-phenyl-3-pyrazolidones or aminophenols.

As the non-diffusive reducing agent (electron donator) that can be used in combination with the electron transfer agent, any one of the aforementioned second reducing agents may be used as far as it is not substantially transferred in layers of the light-sensitive material. Given as preferable examples of the non-diffusive reducing agent are hydroquinones, sulfonamidophenols, sulfonamidonaphthols, compounds described as electron donators in JP-A-53-110827, and non-diffusive and reducible dye-providing compounds explained later. The amount of the second reducing agent to be added in the present invention is generally 0.001 to 20 mol and particularly preferably 0.01 to 10 mol, per mol of silver.

In the light-sensitive material of the present invention, ready-made dyes (pigments and dyes) or compounds which form/release a diffusible dye, can be used, as the color-image forming substance. In order to form a dye image, for example, the light-sensitive material is made to contain a non-diffusive dye-providing compound, and a diffusible dye is made to be released corresponding to or inversely corresponding to a reaction in which a silver ion (silver halide) is reduced to silver, and then the resultant dye is transferred to a mordant sheet.

In the present invention, a compound which promotes both the activation of development and the stabilization of an image may be used in the light-sensitive material. Specific preferable examples of the compound to be used are described in U.S. Pat. No. 4,500,626, columns 51 to 52.

The image-receiving material (dye-fixing material) that can be used for processing the light-sensitive material of the present invention may have either a constitution in which it is formed by application on a separate support differing from that used for the light-sensitive material or a constitution in which it is formed by application on the same support that was used for the light-sensitive material. The relationship between the light-sensitive material and the dye-fixing material, the relationship with the support, and the relationship with the white-color reflecting layer are described in U.S. Pat. No. 4,500,626, column 57, and these relationships may also be applied to the present invention. Because of inclusion of the constitution in which the light-sensitive material and the dye-fixing material are formed by application on the same support, the light-sensitive material is sometimes explained using the term light-sensitive element or photographic element, while the image-receiving material is sometimes explained using the term “image-receiving element” or “dye-fixing element”, for the sake of convenience.

The image-receiving material which is preferably used in the present invention has at least one layer containing a mordant and a binder. As the mordant, one known in the photography field may be used. As specific examples of the mordant, mordants described in U.S. Pat. No. 4,500,626, columns 58 to 59 and JP-A-61-88256, pp. 32-41, and those described in JP-A-62-244043 and JP-A-62-244036 may be given. Also, a dye-receivable polymer compound as described in U.S. Pat. No. 4,463,079 may be used. Auxiliary layers such as a protective layer, a peeling layer, and a curling preventive layer may be provided in the imager-receiving material according to the need. The formation of a protective layer is particularly useful.

As the binder used in structural layers of the light-sensitive material or image-receiving material, hydrophilic ones are preferably used. As examples of the binder, those described in JP-A-62-253159, pp. 26-28 are given. Specifically, transparent or semi-transparent hydrophilic binders are preferable. As examples of the hydrophilic binder, natural compounds, such as proteins (e.g. gelatin and gelatin derivatives), cellulose derivatives, and polysaccharides (e.g. starch, gum arabic, dextran, and pluran); and synthetic polymer compounds, such as polyvinyl alcohols, polyvinylpyrrolidones, and acrylamide polymers, are given. High water-absorptive polymers described in JP-A-62-245260, specifically, homopolymers of vinyl monomers having —COOM or —SO₃M (M represents a hydrogen atom or an alkali metal), or copolymers of these vinyl monomers among them or with another vinyl monomer (e.g., sodium methacrylates, ammonium methacrylates, and Sumikagel L-5H, trade name, manufactured by Sumitomo Kagaku Co., Ltd.) can also be used. These binders may be used in combination of two or more.

When a slight amount of water is supplied to carry out heat development, the absorption of water can be rapidly carried out using the aforementioned high water-absorptive polymer. Also, the use of the high water-absorptive polymer in the mordant layer or its protective layer can prevent a dye from re-transferring from the mordant element to other elements after the dye is transferred.

Known photographic additives which may be used for the heat-developable light-sensitive material or the image-receiving material are described in the aforementioned RD No. 17,643, RD No. 18,716 and RD No. 307,105. The places of corresponding passages are listed in the following table.

| Kind of Additive | | RD 17643 | RD 18716 | RD 307105 |
|---|---|---|---|---|
| 1 | Chemical sensitizers | p. 23 | p. 648 (right column) | p. 866 |
| 2 | Sensitivity-enhancing agents | | p. 648 (right column) | |
| 3 | Spectral sensitizers and | pp. 23-24 | PP. 648 (right column)-649 | pp. 866-868 |
| | Supersensitizers | | (right column) | |
| 4 | Brightening agents | p. 24 | pp. 648 (right column) | p. 868 |
| 5 | Antifogging agents and | pp. 24-25 | p. 649 (right column) | pp. 868-870 |
| | Stabilizers | | | |
| 6 | Light absorbers, Filter | pp. 25-26 | pp. 649 (right column)-650 | p. 873 |
| | dyes, and UV Absorbers | | (left column) | |
| 7 | Dye-image stabilizers | p. 25 | p. 650 (left column) | p. 872 |
| 8 | Hardeners | p. 26 | p. 651 (left column) | pp. 874-875 |
| 9 | Binders | p. 26 | p. 651 (left column) | pp. 873-874 |
| 10 | Plasticizers and | p. 27 | p. 650 (right column) | p. 876 |
| | Lubricants | | | |
| 11 | Coating aids and | pp. 26-27 | p. 650 (right column) | pp. 875-876 |
| | Surfactants | | | |
| 12 | Antistatic agents | p. 27 | p. 650 (right column) | pp. 876-877 |
| 13 | Matt agents | | | pp. 878-879 |

In the present invention, as examples of the support for the light-sensitive material or dye-fixing material, photographic supports, such as paper or synthetic polymers (films), as described in “Fundamentals of Photographic Engineering, Vol.: Silver salt photography” (edited by Nihon Shasin Gakkai and published from Corona, 1979), pp. 223-240 are given. Specific examples include polyethylene terephthalates (PETs), polyethylene naphthalates, polycarbonates, polyvinyl chlorides, polystyrenes, polypropylenes, polyimides, celluloses (e.g., triacetyl cellulose); or those prepared by allowing these films to contain a pigment, such as titanium oxide; papers synthesized by a filming process from a polypropylene; mixed papers made from a synthetic resin pulp, such as a polyethylene, and a natural pulp; Yankee papers, baryta papers, coated papers (cast-coated papers in particular), metals, clothes, glasses, and ceramics. These materials may be used singly. Also, a support prepared by laminating a synthetic polymer, such as a polyethylene, PET, polyester, or polystyrene, on one or both of the surfaces thereof may be used.

Instead of the aforementioned supports, various supports as described, for example, in JP-A-62-253159, pp. (29)-(31); JP-A-1-161236, pp. (14)-(17); JP-A-63-316848, JP-A-2-22651, JP-A-3-56955, and U.S. Pat. No. 5,001,033 may be used.

A hydrophilic binder and a semiconductive metal oxide, such as an alumina sol and tin oxide, carbon black, or other antistatic agents may be applied on the surface of the support. Also, it is also preferable to apply a gelatin and a polymer such as a PVA, to the surface of the support in advance, with the intention of improving the wettability of a coating solution and the adhesion between the applied film and the support.

The thickness of the support varies according to the purpose in use, and a thickness of 40 μm or more and 400 μm or less is generally adopted. However, in the case of a method of forming an image by using elements applied to two or more separate supports, a support with a thickness (5 μm or more and 250 μm or less) lower than the above range is preferably used as the support on the side where the image on the element is not finally used. As such a thin support, for example, a film obtained by depositing aluminum on a PET can be used.

In the case where strict requirements for heat resistance and curling characteristics must be fulfilled, supports for use in a light-sensitive material, as described, for example, in JP-A-6-41281, JP-A-6-43581, JP-A-6-51426, JP-A-6-51437, JP-A-51442, JP-A-6-82961, JP-A-6-82960, JP-A-6-82959, JP-A-6-67346, JP-A-6-202277, JP-6-175282, JP-A-6-118561, JP-A-7-219129, JP-A-7-219144 or the like, may be preferably used.

Example of methods of exposing the light-sensitive material image-wise to thereby record the image include a method in which light emitting diodes or various lasers are allowed to emit light on the basis of image information through electric signals thereby exposing the light-sensitive material, and a method in which image information is output on an image display device such as a CRT, liquid crystal display, electroluminescence display or plasma display, to expose the light-sensitive material either directly or through an optical system. A method, in which a plurality of point light sources, such as LEDs or LDs, are arranged, to expose a plurality of pixels at the same time, is also preferably used as a rapid writing method.

In order to record an image in the light-sensitive material, a light source, such as natural light, a tungsten lamp, a light-emitting diode, a laser light source, or a CRT light source, and an exposure method and a light source, as described in U.S. Pat. No. 4,500,626, column 56, JP-A-2-53378, and JP-A-2-54672 may be used as described above. Also, a light source using a blue-light emitting diode, which has been remarkably developed in recent years, in combination with a green-light emitting diode and a red-light emitting diode may be used. Particularly, exposure apparatuses described in JP-A-7-140567, JP-A-7-248549, JP-A-7-248541, JP-A-7-295115, JP-A-7-290760, JP-A-7-301868, JP-A-7-301869, JP-A-7-306481, and JP-A-8-15788 may be preferably used.

A waveform converting element in which a nonlinear optical material is combined with a coherent light source such as laser light may be used to carry out image exposure. Herein, the nonlinear optical material means materials which can develop nonlinearity in the relationship between the polarization and the electric field, the nonlinearity appearing when a strong photoelectric field like laser light is applied. Inorganic compounds represented by lithium niobate, potassium dihydrogen phosphate (KDP), lithium iodate, and BaB₂O₄; urea derivatives, nitroaniline derivatives, nitropyridine-N-oxide derivatives such as 3-methyl-4-nitropyridine-N-oxide (POM), or compounds described in JP-A-61-53462 and JP-A-62-210432 can be preferably used. As the type of waveform converting element, a monocrystal light waveguide type or a fiber type have been known and these types are all useful.

Also, for the aforementioned image information, image signals obtained from video cameras, electronic still cameras and the like, television signals represented by Nihon Television Signal Standard (NTSC), image signals obtained by, for example, scanners, by dividing an original image into a large number of pixels, and image signals made using a computer represented by CGs or CADs may be utilized.

The image-forming material (the light-sensitive material and/or the image-receiving material) that can be used in the present invention may be used in various applications. For example, the image-receiving material obtained after heat-development transfer may be used as a positive or negative type color print material. Also, the light-sensitive material can be used as black-and-white positive or negative type print materials, printing materials such as lithographic light-sensitive materials, or photographic materials for Roentgen photography, by using a light-sensitive material which uses a mixed material of a black-dye-providing substance or substances providing yellow, magenta, and cyan dyes, respectively.

When the image-forming material of the present invention is used, particularly, as a material printed from a shooting material, it is preferable that using a shooting material having the ability to record information, as described in JP-A-6-163450 or JP-4-338944, the light-sensitive material of the present invention be exposed, to make a print on the dye-fixing material according to the present invention by heat-development transfer. As this printing method, a method described in JP-A-5-241251, JP-A-5-19364 or JP-A-5-19363 may be used. Also, the heat-development transferred light-sensitive material may be used as a shooting material by desilvering the light-sensitive material appropriately. In this case, it is preferable to record shooting information and the like, by using a support having a magnetic substance layer, as described in, for example, JP-A-4-124645, JP-A-5-40321, JP-A-6-35092 or JP-A-6-317875, as the support.

The light-sensitive material and/or the image-receiving material according to the present invention may have a constitution having an electroconductive heating-element layer as heating means used for heat-development and the diffusion transfer of a dye. As the heating element in this case, those described in JP-A-61-145544 and the like may be used.

Heating temperature in the heat development step is generally about 50° C. to 250° C. and particularly preferably about 60° C. to 180° C. A step of diffusion transfer of a dye may be performed either together with heat development or after the heat development step is finished. In the latter case, as to the heating temperature in the transfer step, it is possible to transfer the dye at temperatures ranging from the temperature adopted in the heat development step to ambient temperature. However, the heating temperature is preferably 50° C. or more and lower by about 10° C. than the temperature of the heat development step.

The migration of the dye can be caused only by heat, but a solvent may be used to promote the migration of the dye. A method in which the development and the transfer are carried out either simultaneously or successively under heating in the presence of a small amount of a solvent (especially, water), as described in U.S. Pat. No. 4,704,345 and No. 4,740,445, JP-A-61-238056, and the like, is also useful. In this system, the heating temperature is preferably 50° C. or more and equal to or lower than the boiling point of the solvent. When the solvent is, for example, water, the temperature at the film surface is preferably 50° C. to 100° C. The heating time is preferably 1 to 120 sec.

Examples of the solvent to be used for the promotion of development and/or the diffusion transfer of dye include water, an aqueous basic solution containing an inorganic alkali metal salt or an organic base (as the base, those described in the paragraph concerning the image forming promoter are used), a low-boiling point solvent, or a mixed solution of a low-boiling point solvent and water or the above aqueous basic solution. Also, a surfactant, an antifoggant, a complex-forming compound with a metal salt which is sparingly soluble in water, a mildew-proofing agent, and/or an antibacterial agent may be contained in the solvent.

As the solvent to be used in the heat development and diffusion transfer steps, water is preferably used. As the water, any water which is generally used may be used. Specifically, distilled water, city (tap) water, well water, mineral water or the like may be used. In a heat development apparatus using the image-forming material (the light-sensitive material and the dye-fixing material) according to the present invention, water may be used either in a non-returnable system or repeatedly in a circulatory system. In the latter case, water containing components eluted from materials is eventually used. Also, an apparatus and water described in JP-A-63-144354, JP-A-63-144355, JP-A-62-38460, JP-A-3-210555 and the like may be used. Each of these solvents may be used in a method in which it is supplied to the light-sensitive material, it is supplied to the dye-fixing material or it is supplied to the both of these materials. The amount of the solvent to be used may be equal to or less than the mass of the solvent corresponding to the maximum swelling volume of the whole coated film.

As the method of supplying water, for example, the method described in JP-A-62-253159, page (5) and JP-A-63-85544 is preferably used. The solvent may be confined in microcapsules, or may take the form of a hydrate, to be previously incorporated into either or both of the light-sensitive material and the dye-fixing element, for use. The temperature of the supplied water may be from 30° C. to 60° C. as described in the above-mentioned JP-A-63-85544, and the like.

To accelerate the dye transfer, a system can be adapted where a hydrophilic heat solvent that is solid at normal temperatures and melts at a higher temperature, can be built in the light-sensitive material and/or the dye-fixing element. The layer wherein the hydrophilic heat solvent is built in, may be any of the light-sensitive silver halide emulsion layer, the intermediate layer, the protective layer, and the dye-fixing layer, but preferably it is built-in the dye-fixing layer and/or the layer adjacent thereto. Examples of the hydrophilic heat solvent include ureas, pyridines, amides, sulfonamides, imides, alcohols, oximes, and other heterocyclic compounds.

The heating method in the development and/or transfer steps include a method in which the light-sensitive material is brought into contact with a heated block or plate, a method in which the light-sensitive material is made to be in contact with a hot plate, a hot presser, a heat roller, a heat drum, a halogen lamp heater, or an infrared or far infrared lamp heater, and a method in which the light-sensitive material is made to pass through a high temperature atmosphere. As a method of overlapping the light-sensitive material on the image-receiving material, a method described in JP-A-62-253159 or JP-A-61-147244, page (27) may be applied.

For the processing of the photographic element according to the present invention, any one of various development apparatuses may be used according to need. For example, apparatuses described in JP-A-59-75247, JP-A-59-177547, JP-A-59-181353, JP-A-60-18951, JU-A-62-25944 (“JU-A” means unexamined published Japanese utility-model application), JP-A-6-130509, JP-A-6-95338, JP-A-6-95267, JP-A-8-29955, and JP-A-8-29954 and the like are preferably used. Also, as commercially available apparatus, for example, Pictrostat 100, Pictrostat 200, Pictrostat 300, Pictrostat 330, Pictrography 3000, Pictrography 3500, and Pictrography 4000 (trade names, manufactured by Fuji Photo Film Co., Ltd.) may be used.

The heat-developable color light-sensitive material of the present invention is improved in developing temperature dependency and obtains a print with a good white background.

The present invention will be explained in more detail based on the following examples, which are not intended to be limiting of the present invention.

### EXAMPLES

In the following examples, a compound represented by formula (I) will be referred to as a white-background controlling agent.

### Example 1

First, a preparation method of an image-receiving material will be explained. Coating was carried out onto a support shown in Table 1, to have a layer constitution shown in Table 2. In this way, an image-receiving material 100 was prepared.

TABLE 1
Constitution of Support

| | | | Film |
|---|---|---|---|
| | | | thickness |
| Name of layer | Composition | | (μm) |
| Surface undercoat layer | Gelatin | | 0.1 |
| Surface PE layer (Glossy) | Low-density polyethylene (PE) | 90.2 parts by mass | 36.0 |
| | (Density 0.923): | | |
| | Fluorescent whitening agent (1) | 0.001 parts by mass | |
| | Surface-processed titanium oxide: | 9.8 parts by mass | |
| | Ultramarine: | 0.001 parts by mass | |

| | | |
|---|---|---|
| Pulp layer | Fine quality paper (LBKP/NBSP = 6/4, Density 1.053) | 152.0 |
| Back-surface PE layer (Matt) | High-density polyethylene (Density 0.955) | 27.0 |
| Back-surface undercoat layer | Styrene/acrylate copolymer | 0.1 |
| | Colloidal silica | |
| | Polystyrenesulfonic acid sodium salt | |
| | | 215.2 |

TABLE 2
Constitution of Image-receiving material 100

| | | Coating amount |
|---|---|---|
| Layer number | Additive | (mg/m²) |
| Sixth layer | Water-soluble polymer (1) | 130 |
| | Water-soluble polymer (2) | 35 |
| | Water-soluble polymer (3) | 45 |
| | Potassium nitrate | 20 |
| | Anionic surfactant (1) | 6 |
| | Anionic surfactant (2) | 6 |
| | Amphoteric surfactant (1) | 50 |
| | Stain-preventing agent (1) | 7 |
| | Stain-preventing agent (2) | 12 |
| | Matt agent (1) | 7 |
| Fifth layer | Gelatin | 570 |
| | Anionic surfactant (3) | 25 |
| | Ultraviolet absorber | 500 |
| | Compound (4) | 200 |
| | Hardener (1) | 60 |
| Fourth layer | Mordant (2) | 1850 |
| | Water-soluble polymer (2) | 260 |
| | Water-soluble polymer (4) | 1400 |
| | Dispersion of latex (1) | 600 |
| | Anionic surfactant (3) | 25 |
| | Nonionic surfactant (1) | 18 |
| | Guanidine picolinate | 2550 |
| | Sodium guinolinate | 350 |
| Third layer | Gelatin | 370 |
| | Mordant (1) | 300 |
| | Anionic surfactant (3) | 12 |
| Second layer | Gelatin | 700 |
| | Mordant (1) | 290 |
| | Water-soluble polymer (1) | 55 |
| | Water-soluble polymer (2) | 330 |
| | Anionic surfactant (3) | 30 |
| | Guanidine picolinate | 360 |
| | Potassium guinolinate | 45 |
| First layer | Gelatin | 190 |
| | Water-soluble polymer (1) | 8 |
| | Anionic surfactant (1) | 10 |
| | Sodium metaborate | 23 |
| | Hardener (1) | 300 |

Support: Paper Support described in Table 1 (thickness 215 μm)
Note: The coating amount of the dispersion of latex is in terms of the
coating amount of solid content of the latex.
Anionic surfactant (1)

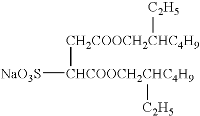

Anionic surfactant (2)

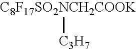

Anionic surfactant (3)

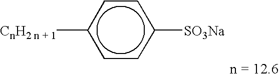

Nonionic surfactant (1)

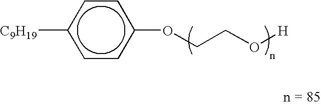

Amphoteric surfactant (1)

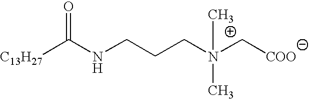

Fluorescent whitening agent (1)

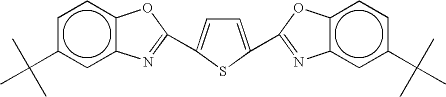

Mordant (1)

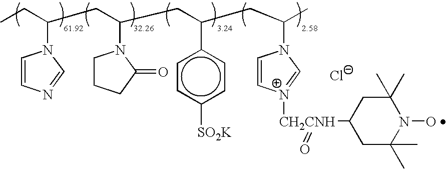

| | |
|---|---|
| Stain-preventing | Stain-preventing |
| agent (1) | agent (2) |
| 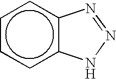 | 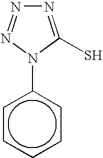 |

| | |
|---|---|
| Water-soluble polymer (1) | SUMIKAGEL L5-H (trade name: |
| | manufacuted by Sumitomo |
| | Kagaku Co.) |
| Water-soluble polymer (2) | Dextran (molecular mass 70,000) |
| Water-soluble polymer (3) | κ (kappa)-Carrageenan (trade name: |
| | manufactured by Taito Co.) |
| 5 Water-soluble polymer (4) | MP POLYMER MP-102 (trade name: |
| | manufactured by Kuraray Co.) |
| Dispersion of latex (1) | LX-438 (trade name: manufactured |
| | by Nippon Zeon Co. |
| Matt Agent (1) | S Y L 0 I D 7 9 (trade name, |
| | manufactured by |
| Hardener (1) | 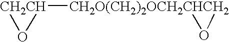 |

Mordant (2)

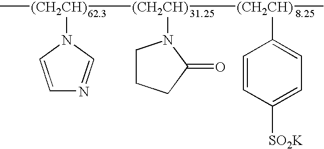

Compound (4)
CRYSTALEX 112 (trade name, manufactured by Hercules Inc.)
Ultraviolet absorber (1)

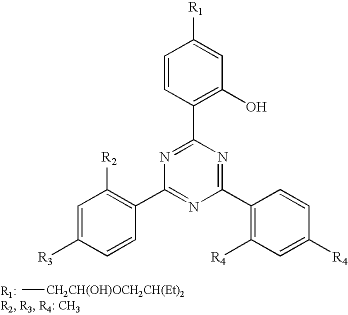

Next, the preparation method of a light-sensitive silver halide emulsion will be explained. Light-sensitive silver halide emulsion (1) (emulsion for the sixth layer (680 nm light-sensitive layer))

Solution (I) and Solution (II) having compositions shown in Table 4 were simultaneously added to a vigorously-stirred aqueous solution having a composition shown in Table 3, over 9 minutes. After 5 minutes from the addition, Solutions (III) and (IV) having compositions shown in Table 4 were added thereto, over 33 minutes and 33 minutes 30 seconds, respectively.

TABLE 3
Composition

| | | |
|---|---|---|
| H₂O | 620 | ml |
| Lime-processed gelatin | 20 | g |
| KBr | 0.3 | g |
| NaCl | 2 | g |
| Silver halide solvent \textcircled{1} | 0.030 | g |
| Sulfuric acid (1N) | 16 | ml |
| Temperature | 45° | C. |

TABLE 4

| | Solution (I) | Solution (II) | Solution (III) | Solution (IV) |
|---|---|---|---|---|
| AgNO₃ | 30.0 g | None | 70.0 g | None |
| NH₄NO₃ | 0.125 g | None | 0.375 g | None |
| KBr | None | 13.7 g | None | 44.1 g |
| NaCl | None | 3.6 g | None | 2.4 g |
| K₂IrCl₆ | None | None | None | 0.039 mg |
| Total volume | Water to | Water to | Water to | Water to |
| | make | make | make | make |
| | 126 ml | 132 ml | 254 ml | 252 ml |

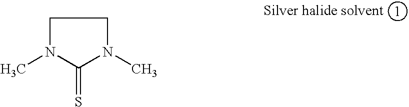

Further, after 15 minutes from the start of addition of Solution (III), 150 ml of an aqueous solution containing 0.350% of Sensitizing dye <1> was added over 27 minutes.

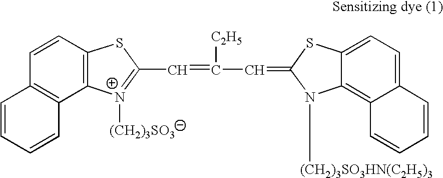

After washing with water and desalting (that was carried out using Settling agent a, at a pH of 4.1) in a usual manner, 22 g of lime-processed ossein gelatin was added, and then, after adjusting the pH and pAg to 6.0 and 7.9 respectively, chemical sensitization was carried out at 60° C. The compounds used in the chemical sensitization are shown in Table 5. In this way, 630 g of a monodisperse cubic silver chlorobromide emulsion having a deviation coefficient of 10.2% and an average grain size of 0.22 μm was obtained.

TABLE 5

| Chemicals used in chemical sensitization | Added amount | |
|---|---|---|
| 4-Hydroxy-6-methyl-1,3,3a,7-tetrazaindene | 0.36 | g |
| Sodium thiosulfate | 6.75 | mg |
| Antifoggant \hat{1} | 0.11 | g |
| Antiseptic \hat{1} | 0.07 | g |
| Antiseptic \hat{2} | 3.13 | g |

Settling agent a.

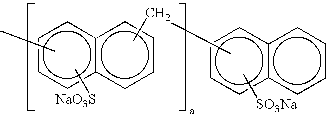

Antifoggant \hat{1}

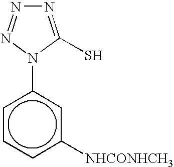

Antiseptic \hat{1}

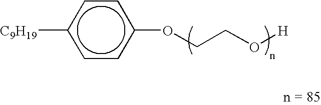

Antiseptic \hat{2}

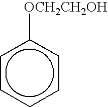

Light-sensitive silver halide emulsion (2) (emulsion for the fourth layer (750 nm light-sensitive layer))

Solution (I) and Solution (II) having compositions shown in Table 7 were simultaneously added to a vigorously-stirred aqueous solution having a composition shown in Table 6, over 18 minutes. After 5 minutes from the addition, Solutions (III) and (IV) having compositions shown in Table 7 were added thereto, over 24 minutes and 24 minutes 30 seconds, respectively.

TABLE 6
Composition

| | | |
|---|---|---|
| H₂O | 620 | ml |
| Lime-processed gelatin | 20 | g |
| KBr | 0.3 | g |
| NaCl | 2 | g |
| Silver halide solvent \textcircled{1} | 0.030 | g |
| Sulfuric acid (1N) | 16 | ml |
| Temperature | 41° | C. |

TABLE 7

| | | | | Solution |
|---|---|---|---|---|
| | Solution (I) | Solution (II) | Solution (III) | (IV) |
| AgNO₃ | 30.0 g | None | 70.0 g | None |
| NH₄NO₃ | 0.125 g | None | 0.375 g | None |
| KBr | None | 14.2 g | None | 43.7 g |
| NaCl | None | 3.8 g | None | 2.4 g |
| K₄[Fe(CN)₆].H₂O | None | None | None | 0.065 g |
| K₂IrCl₆ | None | None | None | 0.057 mg |
| Total volume | Water to | Water to | Water to | Water to |
| | make | make | make | make |
| | 188 ml | 188 ml | 250 ml | 250 ml |

After washing with water and desalting (that was carried out using Settling agent b at a pH of 3.9) in a usual manner, 22 g of lime-processed ossein gelatin from which calcium had been removed (the calcium content: 150 ppm or less) was added, re-dispersing was made at 40° C., 0.39 g of 4-hydroxy-6-methyl-1,3,3a,7-tetrazaindene was added, and the pH and pAg were adjusted to 5.9 and 7.8 respectively. Thereafter, chemical sensitization was carried out at 60° C. The chemicals used in the chemical sensitization are shown in Table 8. During the chemical sensitization, Sensitizing Dye <2> in the form of a methanol solution (the solution having the composition shown in Table 9) was added. After the chemical sensitization, the temperature was lowered to 50° C. and then 200 g of a gelatin dispersion of the Stabilizer <1>, which will be explained later, was added, followed by stirring well, and kept in a casing. In this way, 938 g of a monodisperse cubic silver chlorobromide emulsion having a deviation coefficient of 12.6% and an average grain size of 0.23 μm was obtained.

TABLE 8

| | Added | |
|---|---|---|
| Chemicals used in chemical sensitization | amount | |
| 4-Hydroxy-6-methyl-1,3,3a,7-tetrazaindene | 0.39 | g |
| Triethylthiourea | 3.3 | mg |
| Nucleic acid decomposition product | 0.39 | mg |
| NaCl | 0.15 | g |
| KI | 0.12 | g |
| Antifoggant \textcircled{2} | 0.10 | g |
| Antiseptic \textcircled{1} | 0.07 | g |

TABLE 9

| Composition of dye solution | Added amount |
|---|---|
| Sensitizing dye <2> | 0.19 g |
| Methanol | 18.7 ml |

Stabilizer (1)

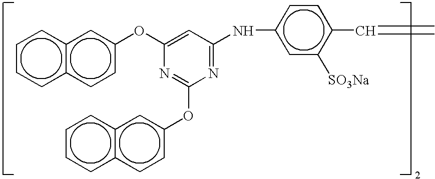

Antifoggant \hat{2}

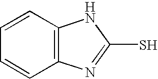

Sensitizing dye \hat{2}

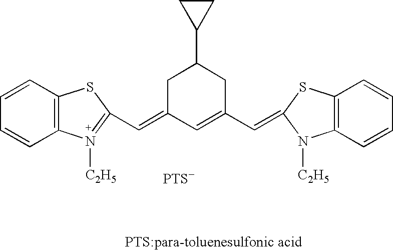

Settling agent b.

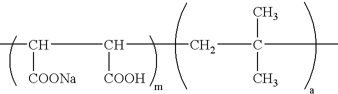

Light-sensitive silver halide emulsion (3) (emulsion for the second layer (810 nm light-sensitive layer))

Solution (I) and Solution (II) having compositions shown in Table 11 were simultaneously added to a vigorously-stirred aqueous solution having a composition shown in Table 10, over 18 minutes. After 5 minutes from the addition, Solution (III) and Solution (IV) having compositions shown in Table 11 were added thereto over 24 minutes and 24 minutes 30 seconds, respectively.

TABLE 10
Composition

| | | |
|---|---|---|
| H₂O | 620 | ml |
| Lime-processed gelatin | 20 | g |
| KBr | 0.3 | g |
| NaCl | 2 | g |
| Silver halide solvent \textcircled{1} | 0.030 | g |
| Sulfuric acid (1N) | 16 | ml |
| Temperature | 50° | C. |

TABLE 11

| | | | | Solution |
|---|---|---|---|---|
| | Solution (I) | Solution (II) | Solution (III) | (IV) |
| AgNO₃ | 30.0 g | None | 70.0 g | None |
| NH₄NO₃ | 0.125 g | None | 0.375 g | None |
| KBr | None | 13.7 g | None | 44.1 g |
| NaCl | None | 3.6 g | None | 2.4 g |
| K₄[Fe(CN)₆].H₂O | None | None | None | 0.04 g |
| K₂IrCl₆ | None | None | None | 0.020 mg |
| Total volume | Water to | Water to | Water to | Water to |
| | make | make | make | make |
| | 180 ml | 181 ml | 242 ml | 250 ml |

After washing with water and desalting (that was carried out using Settling agent a, at a pH of 3.8) in a usual manner, 22 g of lime-processed ossein gelatin was added, and then, after adjusting the pH and pAg to 7.4 and 7.8 respectively, chemical sensitization was carried out at 60° C. The compounds used in the chemical sensitization are shown in Table 12. In this way, 683 g of a monodisperse cubic silver chlorobromide emulsion having a deviation coefficient of 9.7% and an average grain size of 0.32 μm was obtained.

TABLE 12

| | Added | |
|---|---|---|
| Chemicals used in chemical sensitization | amount | |
| 4-Hydroxy-6-methyl-1,3,3a,7-tetrazaindene | 0.38 | g |
| Triethylthiourea | 3.10 | mg |
| Antifoggant \textcircled{2} | 0.19 | g |
| Antiseptic \textcircled{1} | 0.07 | g |
| Antiseptic \textcircled{2} | 3.13 | g |

Next, the preparation method of a silver chloride fine-grain, to be added to the second layer (810 nm light-sensitive layer), is described below.

Solution (I) and Solution (II) having compositions shown in Table 14 were simultaneously added to a vigorously-stirred aqueous solution having a composition shown in Table 13, over 4 minutes. After 3 minutes from the addition, Solutions (III) and (IV) having compositions shown in Table 14 were added thereto, over 8 minutes.

TABLE 13
Composition

| | | |
|---|---|---|
| H₂O | 3770 | ml |
| Lime-processed gelatin | 60 | g |
| NaCl | 0.8 | g |
| Temperature | 38° | C. |

TABLE 14

| | Solution (I) | Solution (II) | Solution (III) | Solution (IV) |
|---|---|---|---|---|
| AgNO₃ | 300 g | None | 300 g | None |
| NH₄NO₃ | 10 g | None | 10 g | None |
| NaCl | None | 108 g | None | 104 g |
| Total | Water to make | Water to make | Water | Water |
| volume | 940 ml | 940 ml | to make | to make |
| | | | 1170 ml | 1080 ml |

After washing with water and desalting (that was carried out using Settling agent a at a pH of 3.9) in a usual manner, 132 g of lime-processed ossein gelatin was added, re-dispersing was made at 35° C., 4 g of 4-hydroxy-6-methyl-1,3,3a,7-tetrazaindene was added, and the pH was adjusted to 5.7. The yield of the resulting silver chloride fine-grain emulsion was 3,200 g, whose average grain size was 0.10 μm.

Next, the preparation method of a gelatin dispersion of colloidal silver is described below.

To a well-stirred aqueous solution having the composition shown in Table 15, was added a solution having the composition shown in Table 16, over 24 minutes. Thereafter, the washing with water using Settling agent a was carried out, then 43 g of lime-processed ossein gelatin was added, and the pH was adjusted to 6.3. In this way, 512 g of a dispersion having average grain size of 0.02 μm, and containing silver 2% and gelatin 6.8% was obtained.

TABLE 15
Composition

| | | |
|---|---|---|
| H₂O | 620 | ml |
| Dextrin | 16 | g |
| NaOH (5N) | 41 | ml |
| Temperature | 30° | C. |

TABLE 16
Composition

| | | |
|---|---|---|
| H₂O | 135 | ml |
| AgNO₃ | 17 | g |

The preparation methods of gelatin dispersions of hydrophobic additives are described.

Gelatin dispersions of a yellow-dye-providing compound, a magenta-dye-providing compound, and a cyan-dye-providing compound, whose formulations are shown in Table 17, were prepared, respectively. That is, the oil phase components were dissolved by heating to about 70° C., to form a uniform solution, and to the resultant solution, were added the aqueous phase components that had been heated to about 60° C., followed by stirring to mix and dispersing by a homogenizer for 10 minutes at 10,000 rpm. To the resultant dispersion, was added additional water, followed by stirring, to obtain a uniform dispersion. Furthermore, the resultant gelatin dispersion of the cyan dye-providing compound was repeatedly diluted with water and concentrated using an ultrafiltration module (ultrafiltration module: ACV-3050, trade name, made by Asahi Chemical Co., Ltd.), so that the amount of ethyl acetate would be 1/17.6 of the amount thereof shown in Table 17.

TABLE 17
Dispersionof yellow-dye-providing compound

| | | | |
|---|---|---|---|
| Oil | Yellow-dye-providing compound \hat{1} | 7.39 | g |
| phase | Yellow-dye-providing compound \hat{2} | 3.08 | g |
| | Dye (a) | 1.09 | g |
| | Reducing agent <1> | 0.43 | g |
| | High-boiling solvent \hat{2} | 1.66 | g |
| | High-boiling solvent \hat{2} | 3.70 | g |
| | High-boiling solvent \hat{3} | 1.85 | g |
| | Antifoggant \hat{3} | 0.16 | g |
| | Cyan-dye-providing compound \hat{2} | 0.01 | g |
| | Ethyl acetate | 10.71 | ml |
| | Water | | |
| Aqueous | Lime-processed gelatin | 10.00 | g |
| phase | Surfactant \hat{1} | 1.46 | g |
| | Calcium nitrate | 0.14 | g |
| | Antiseptic \hat{3} | 0.00 | g |
| | Water | 26 | ml |

| | | |
|---|---|---|
| Additional water | 99.9 | ml |

Dispersionof cyan-dye-providing compound

| | | | |
|---|---|---|---|
| Oil | Cyan-dye-providing compound \hat{1} | 15.49 | g |
| phase | Dye (a) | 0.47 | g |
| | White background controlling agent-A | 0.74 | g |
| | Reducing agent <1> | 1.48 | g |
| | High-boiling solvent \hat{1} | 4.65 | g |
| | High-boiling solvent \hat{2} | 15.51 | g |
| | Antifoggant \hat{3} | 0.19 | g |
| | Ethyl acetate | 49.58 | ml |
| Aqueous | Lime-processed gelatin | 10.00 | g |
| phase | Carboxymethyl cellulose | 0.25 | g |
| | Surfactant \hat{1} | 2.18 | g |
| | Sodium hydrogensulfite | 0.21 | g |
| | Antiseptic \hat{3} | 0.10 | g |
| | Water | 96.00 | ml |

| | | |
|---|---|---|
| Additional water | 201.00 | ml |

Dispersion of magenta-dye-providing compound

| | | | |
|---|---|---|---|
| Oil | Magenta-dye-providing compound \hat{1} | 17.214 | g |
| phase | Reducing agent <1> | 0.206 | g |
| | High-boiling solvent \hat{2} | 8.607 | g |
| | Antifoggant \hat{4} | 1.0365 | g |
| | Ethyl acetate | 25.08 | ml |
| Aqueous | Lime-processed gelatin | 10 | g |
| phase | Surfactant \hat{1} | 2.08 | g |
| | Calcium nitrate | 0.14 | g |
| | Antiseptic \hat{3} | 0.004375 | g |
| | Water | 50 | ml |

| | | |
|---|---|---|
| Additional water | 140 | ml |

Cyan-dye-providing compound \hat{1}

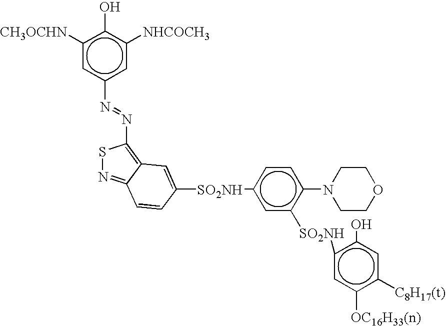

Cyan-dye-providing compound \hat{2}

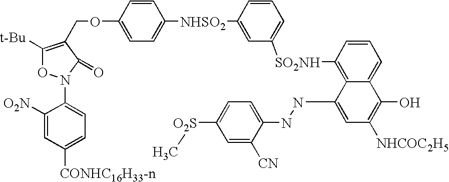

Dye (a)

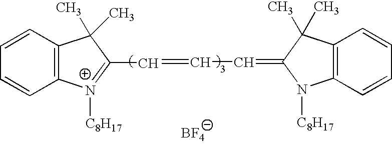

Magenta-dye-providing compound \hat{1}

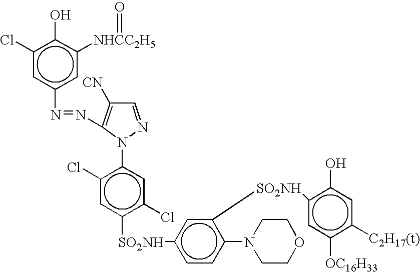

Yellow-dye-providing compound \hat{1}

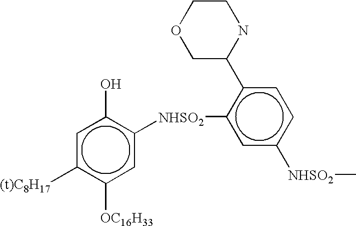

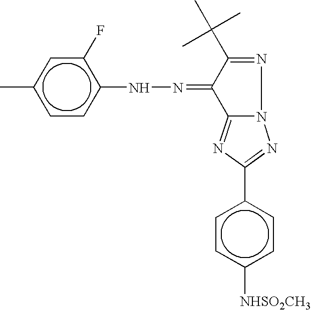

Yellow-dye-providing compound \hat{2}

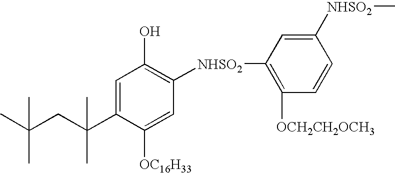

Reducing agent (1)

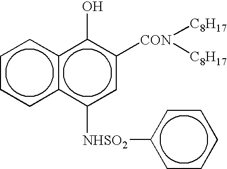

Antifoggant \hat{3}

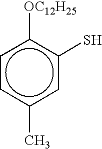

Antifoggant \hat{4}

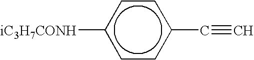

Surfactant \hat{1}

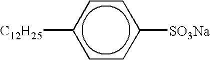

High-boiling solvent \hat{1}

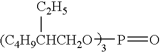

High-boiling solvent \hat{2}

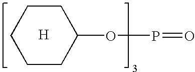

High-boiling solvent \hat{3}

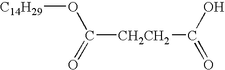

Antiseptic \hat{3}

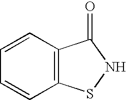

A gelatin dispersion of Reducing agents <2> and <4>, whose formulation is shown in Table 18, was prepared. Specifically, the oil phase components were dissolved by heating to about 60° C., to form a solution, and to the resultant solution, were added the aqueous phase components that had been heated to about 60° C., and after stirring and mixing them, the resultant mixture was dispersed for 10 minutes at 10,000 rpm by a homogenizer, to obtain a uniform dispersion. From the thus-obtained dispersion, ethyl acetate was removed off using a vacuum organic solvent removing apparatus.

TABLE 18

| | | Composition of | |
|---|---|---|---|
| | | dispersion | |
| Oil | Reducing agent <2> | 1.25 | g |
| phase | Reducing agent <4> | 9.23 | g |
| | High-boiling solvent \hat{2} | 4.7 | g |
| | Surfactant \hat{1} | 2.7 | g |
| | Ethyl acetate | 14.4 | ml |
| Aqueous | Acid-processed gelatin | 10.0 | g |
| phase | Antiseptic \hat{3} | 0.02 | g |
| | Antiseptic \hat{4} | 0.04 | g |
| | Sodium hydrogensulfite | 0.1 | g |
| | Water | 136.7 | ml |

Reducing agent (2)

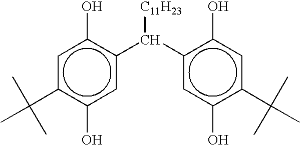

Reducing agent (4)

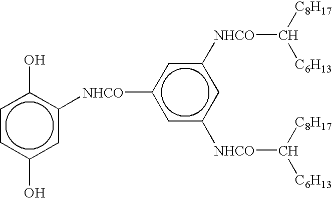

Antiseptic \hat{4}

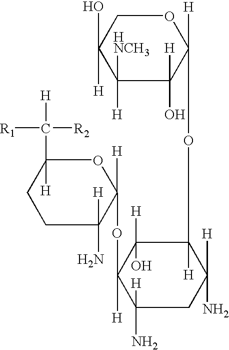

| | R₁ | R₂ |
|---|---|---|
| C₁ | H₃C— | —NHCH₃ |
| C₂ | H₃C— | —NH₂ |
| C₁₀ | H— | —NH₂ |
| C₂₀ | H— | —NHCH₃ |

A gelatin dispersion of Stabilizer <1>, whose formulation is shown in Table 19, was prepared. Specifically, the oil phase components were dissolved at room temperature, to form a solution, and to the resultant solution, were added the aqueous phase components that had been heated to about 40° C., and after stirring and mixing them, the resultant mixture was dispersed for 10 minutes at 10,000 rpm by a homogenizer. To the resultant dispersion, was added additional water, followed by stirring, thereby obtaining a uniform dispersion.

TABLE 19

| | | Composition | |
|---|---|---|---|
| | | of dispersion | |
| Oil phase | Stabilizer <1> | 4.0 | g |
| | Sodium hydroxide | 0.3 | g |
| | Methanol | 62.8 | g |
| | High-boiling solvent \textcircled{2} | 0.9 | g |
| Aqueous | Gelatin from which calcium had been removed | 10 | g |
| phase | (Ca content 100 ppm or less) | | |
| | Antiseptic \textcircled{1} | 0.04 | g |
| | Water | 320.5 | ml |

A gelatin dispersion of zinc hydroxide was prepared according to the formulation shown in Table 20. Specifically, after the components were mixed and dissolved, dispersing was carried out for 30 minutes in a mill, using glass beads having an average particle diameter of 0.75 mm. Then the glass beads were separated and removed off, to obtain a uniform dispersion. (Zinc hydroxide having an average particle size of 0.25 μm was used.)

TABLE 20

| | Composition of | |
|---|---|---|
| | dispersion | |
| Zinc hydroxide | 15.9 | g |
| Carboxymethyl cellulose | 0.7 | g |
| Poly(sodium acrylate) | 0.07 | g |
| Lime-processed gelatin | 3.2 | g |
| Water | 100 | ml |

Next, the preparation method of a gelatin dispersion of a matt agent that was to be added to the protective layer is described below.

A solution containing PMMA dissolved in methylene chloride was added, together with a small amount of a surfactant, to gelatin, and they were stirred and dispersed at high speed. Then the methylene chloride was removed off using a vacuum solvent removing apparatus, to obtain a uniform dispersion having an average particle size of 4.3 μm.

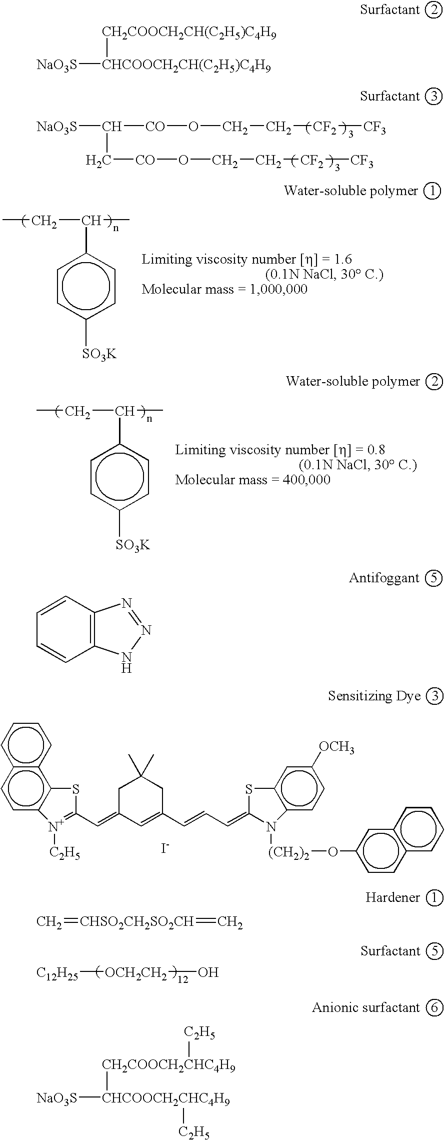

Using the above materials, Heat-developable light-sensitive material 201 shown in Table 21 was prepared.

TABLE 21
Constitution of Main Materials of Heat-Developable Light-sensitive Material

| | | Additive | Coating amount (mg/m²) |
|---|---|---|---|
| Eighth layer | Protective layer | Acid-processed gelatin | 610.8 |
| | | Reducing agent <2> | 24.9 |
| | | Reducing agent <4> | 183.5 |
| | | Colloidal silver grain | 2.7 |
| | | Matt agent (PMMA resin) | 23.6 |
| | | Surfactant \textcircled{2} | 53.1 |
| | | Surfactant \textcircled{3} | 2.7 |
| | | Surfactant \textcircled{1} | 53.8 |
| | | Sodium hydrogensulfite | 2.0 |
| | | High-boiling solvent \textcircled{2} | 94.4 |
| | | Antiseptic \textcircled{3} | 0.9 |
| | | Calcium nitrate | 6.0 |
| | | Sodium hydroxide | 4.1 |
| Seventh | Intermediate | Lime-processed gelatin | 798.1 |
| layer | layer | Zinc hydroxide | 542.6 |
| | | Antifoggant \textcircled{3} | 102.0 |
| | | Citric acid | 7.3 |
| | | Carboxymethyl cellulose | 22.3 |
| | | Sodium hydroxide | 2.8 |
| | | Calcium nitrate | 12.9 |
| | | Surfactant \textcircled{5} | 45.1 |
| | | Surfactant \textcircled{2} | 0.4 |
| | | Water-soluble polymer \textcircled{1} | 5.4 |
| Sixth layer | 680 nm-light- | Light-sensitive silver halide emulsion (1) | 197.9 |
| | sensitive layer | | (in terms of silver) |
| | | Lime-processed gelatin | 205.2 |
| | | Calcium nitrate | 2.9 |
| | | Antiseptic \textcircled{3} | 0.1 |
| | | Magenta-dye-providing compound \textcircled{1} | 353.2 |
| | | Reducing agent <1> | 4.2 |
| | | High-boiling solvent \textcircled{2} | 176.6 |
| | | Surfactant \textcircled{1} | 42.7 |
| | | Antifoggant \textcircled{4} | 21.3 |
| | | Water-soluble polymer \textcircled{1} | 0.7 |
| Fifth layer | Intermediate | Lime-processed gelatin | 536.1 |
| | layer | Zinc hydroxide | 364.5 |
| | | Antiseptic \textcircled{3} | 68.5 |
| | | Citric acid | 4.9 |
| | | Carboxymethyl cellulose | 15.0 |
| | | Sodium hydroxide | 1.8 |
| | | Calcium nitrate | 8.7 |
| | | Surfactant \textcircled{5} | 30.3 |
| | | Surfactant \textcircled{2} | 0.3 |
| | | Water-soluble polymer \textcircled{1} | 3.6 |
| Fourth layer | 750 nm-light- | Light-sensitive silver halide emulsion (2) | 204.3 |
| | sensitive layer | | (in terms of silver) |
| | | Lime-processed gelatin | 230.0 |
| | | Stabilizer <1> | 10.8 |
| | | Sodium hydroxide | 0.9 |
| | | Antiseptic \textcircled{3} | 0.2 |
| | | Carboxymethyl cellulose | 5.1 |
| | | Cyan-dye-providing compound \textcircled{1} | 314.3 |
| | | Dye (a) | 9.6 |
| | | White-background-controlling agent A | 14.9 |
| | | Reducing agent <1> | 30.1 |
| | | High-boiling solvent \textcircled{1} | 94.3 |
| | | High-boiling solvent \textcircled{2} | 314.8 |
| | | Sodium hydrogensulfite | 4.3 |
| | | Surfactant \textcircled{1} | 44.2 |
| | | Antifoggant \textcircled{3} | 3.8 |
| Third layer | Intermediate | Lime-processed gelatin | 859.5 |
| | layer | Antifoggant \textcircled{3} | 1.7 |
| | | Citric acid | 9.5 |
| | | Calcium nitrate | 14.0 |
| | | Surfactant \textcircled{2} | 3.4 |
| | | Surfactant \textcircled{5} | 60.2 |
| | | Antifoggant \textcircled{5} | 7.3 |
| | | Water-soluble polymer \textcircled{2} | 9.1 |
| Second layer | 810 nm-light- | Light-sensitive silver halide emulsion (3) | 255.5 |
| | sensitive layer | | (in terms of silver) |
| | | Sensitizing dye \textcircled{3} | 0.1 |
| | | Lime-processed gelatin | 36.2 |
| | | Stabilizer <1> | 14.5 |
| | | Sodium hydroxide | 2.8 |
| | | Antiseptic \textcircled{3} | 0.4 |
| | | Antiseptic \textcircled{4} | 2.9 |
| | | Yellow-dye-providing compound \textcircled{1} | 258.1 |
| | | Yellow-dye-providing compound \textcircled{2} | 107.6 |
| | | Lime-processed gelatin | 349.3 |
| | | Cyan-dye-providing compound \textcircled{2} | 0.4 |
| | | Calcium nitrate | 4.9 |
| | | Dye (a) | 37.9 |
| | | Reducing agent <1> | 14.9 |
| | | High-boiling solvent \textcircled{1} | 58.1 |
| | | High-boiling solvent \textcircled{2} | 129.1 |
| | | High-boiling solvent \textcircled{3} | 64.6 |
| | | Surfactant \textcircled{1} | 51.0 |
| | | Antifoggant \textcircled{3} | 5.6 |
| | | Fine-grain silver chloride emulsion | 34.9 |
| | | | (in terms of silver) |
| | | Water-soluble polymer \textcircled{2} | 38.0 |
| | | Hardener \textcircled{1} | 58.1 |
| First layer | Undercoat layer | Lime-processed gelatin | 201.1 |
| | | Antiseptic \textcircled{3} | 0.4 |
| | | Citric acid | 2.2 |
| | | Calcium nitrate | 3.3 |
| | | Surfactant \textcircled{2} | 0.8 |
| | | Surfactant \textcircled{5} | 14.1 |
| | | Antiseptic \textcircled{4} | 0.0 |
| | | Antifoggant \textcircled{5} | 1.7 |
| | | Water-soluble polymer \textcircled{1} | 2.1 |
| | | Water-soluble polymer \textcircled{2} | 4.8 |

Paper support laminated with polyethylene: thickness 131 μm
(Note)
Conventional additives used in trace amounts, such as an antiseptic, were omitted from description.

Next, light-sensitive materials 202 to 209 were produced in the same manner as in the production of the light-sensitive material 201, except that the white-background-controlling agent A used in the light-sensitive material 201 was altered to the respective compounds shown in the following Table 22. Also, for comparison, a light-sensitive material that had the same composition to the light-sensitive material 201, except that the white-background-controlling agent was removed, was prepared as a comparative material R-301.

TABLE 22

| | | Amount of white- | Addition point of white- |
|---|---|---|---|
| Light-sensitive | White-background | background controlling | background controlling |
| material | controlling agent | agent (mg/m²) | agent |
| 201 | A | 14.9 | 4th layer |
| 202 | B | 15.2 | 4th layer |
| 203 | C | 16.5 | 4th layer |
| 204 | D | 19.5 | 4th layer |
| 205 | E | 21.5 | 4th layer |
| 206 | F | 21.0 | 4th layer |
| 207 | A | 14.9 | 2nd layer |
| 208 | C + D | C 8.3 D9.3 | 4th layer |
| 209 | E + F | E 10.3 F 10.5 | 6th layer |
| R-301 | None | None | — |

White-background-controlling agent-A
(The same as Compound 1, the compound of fomula (I) according to the
present invention)

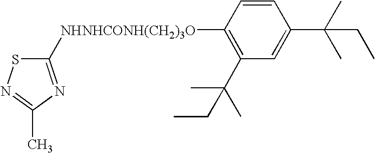

White-background-controlling agent-B
(The same as Compound 2, the compound of fomula (I) according to the
present invention)

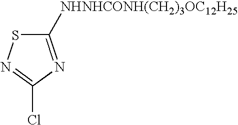

White-background-controlling agent-C
(The same as Compound 3, the compound of fomula (I) according to the
present invention)

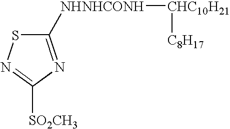

White-background-controlling agent-D
(The same as Compound 4, the compound of fomula (I) according to the
present invention)

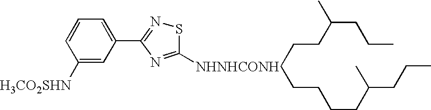

White-background-controlling agent-E
(The same as Compound 5, the compound of fomula (I) according to the
present invention)

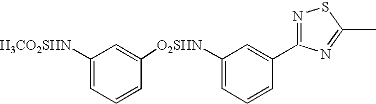

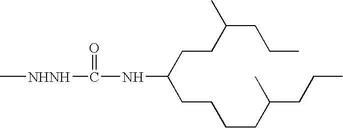

White-background-controlling agent-F
(The same as Compound 6, the compound of fomula (I) according to the
present invention)

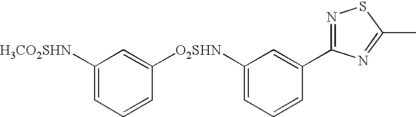

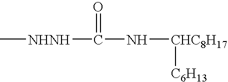

Each light-sensitive material was exposed to light by using the exposure apparatus described in FIG. 2 in JP-A-6-127021, under the conditions shown in Table 23, and then combined with the aforementioned image-receiving material 100, followed by developing treatment performed either at 83° C. for 35 seconds, at 80° C. for 35 seconds, or at 86° C. for 35 seconds, by using Fujix Pictrography 3500 (trade name).

TABLE 23

| | |
|---|---|
| Beam intensity at the | Intensity of 675 nm laser beam: 60 μW |
| surface of the light- | Intensity of 755 nm laser beam: 250 μW |
| sensitive material | Intensity of 815 nm laser beam: 250 μW |
| Scanning line density | 1600 dpi (63 lusters per mm) |
| Beam diameter | 85 ± 8.5 μm in the major scanning direction |
| | 55 ± 5.5 μm in the sub scanning direction |
| Exposure time | Per luster: 667 μsec |
| | Repeat cycle: 1.33 msec |
| Wavelength of exposure | 675, 755, 815 nm (laser light) |
| light | |
| Exposure amount | Variation of 1 logE in every 2.5 cm in the |
| | sub-scanning direction |
| Method of varying | Emission time modulation |
| exposure amount | (method described in JP-A-5-199372) |

The condition of the image obtained by exposure was set as follows: white background, gray having a visual density of 0.7, and Dmax. The results of visual inspection, the measured values of reflection density, and each evaluation of these values are shown in Table 24.

In the table, the standard of the evaluation of the white background is as follows.

◯: The white background is not observed to have colored parts and this is rated as good.

Δ: Though the white background is observed to have colored parts, this is an allowable level.

x: The white background is clearly observed to have colored parts and this is an unallowable level.

The standard of the evaluation of gray and Dmax is as follows.

◯: Density fluctuation is not observed when the light-sensitive material is treated in the conditions differing in developing temperature and this is rated as good.

x: Density fluctuation is observed when the light-sensitive material is treated in the conditions differing in developing temperature and this is unallowable level.

TABLE 24

| | | | | | Developing temperature dependency: a difference in density between treatment at 86° C. for 35 | | | | | | | |
|---|---|---|---|---|---|---|---|---|---|---|---|---|
| | | | | | seconds and treatment at 80° C. for 35 seconds | | | | | | | |
| | | | | | Gray | | | | Dmax | | | |
| | | | | | | Difference | Difference | Difference | | Difference | Difference | Difference |
| Light- | Image- | White background | | | | between | between | between | | between | between | between |
| sensitive | receiving | 80° C. | 83° C. | 86° C. | | yellow | magenta | cyan | | yellow | magenta | cyan |
| material | material | 35 sec | 35 sec | 35 sec | Evaluation | densities | densities | densities | Evaluation | densities | densities | densities |
| 201 | 100 | ◯ | ◯ | ◯ | ◯ | 0.22 | 0.24 | 0.18 | ◯ | 0.21 | 0.25 | 0.15 |
| 202 | 100 | ◯ | ◯ | ◯ | ◯ | 0.21 | 0.25 | 0.20 | ◯ | 0.26 | 0.26 | 0.16 |
| 203 | 100 | ◯ | ◯ | ◯ | ◯ | 0.23 | 0.24 | 0.22 | ◯ | 0.25 | 0.26 | 0.18 |
| 204 | 100 | ◯ | ◯ | ◯ | ◯ | 0.20 | 0.24 | 0.19 | ◯ | 0.28 | 0.28 | 0.21 |
| 205 | 100 | ◯ | ◯ | ◯ | ◯ | 0.19 | 0.25 | 0.22 | ◯ | 0.23 | 0.21 | 0.23 |
| 206 | 100 | ◯ | ◯ | ◯ | ◯ | 0.21 | 0.24 | 0.15 | ◯ | 0.21 | 0.26 | 0.24 |
| 207 | 100 | ◯ | ◯ | ◯ | ◯ | 0.22 | 0.23 | 0.16 | ◯ | 0.25 | 0.23 | 0.21 |
| 208 | 100 | ◯ | ◯ | ◯ | ◯ | 0.21 | 0.22 | 0.21 | ◯ | 0.25 | 0.24 | 0.23 |
| 209 | 100 | ◯ | ◯ | ◯ | ◯ | 0.19 | 0.23 | 0.20 | ◯ | 0.21 | 0.26 | 0.21 |
| R-301 | 100 | X | Δ | X | X | 0.35 | 0.40 | 0.45 | X | 0.40 | 0.45 | 0.54 |
| | | Cyan | Cyan | Magenta | | | | | | | | |
| | | tint | tint | tint | | | | | | | | |

As shown in the above results, Comparative Example R-301 was significantly tinged with cyan in the developing treatment carried out at 80° C. for 35 seconds, slightly tinged with cyan in the developing treatment carried out at 83° C. for 35 seconds, and tinged with magenta in the developing treatment carried out at 86° C. for 35 seconds. Comparative Example R-301 was therefore inferior in the characteristics as to white background and also in developing temperature dependency. Contrary, any of the light-sensitive materials 201 to 209 each containing the compound (I) according to the present invention had a good white background and good developing temperature dependency.

Having described our invention as related to the present embodiments, it is our intention that the invention not be limited by any of the details of the description, unless otherwise specified, but rather be construed broadly within its spirit and scope as set out in the accompanying claims.

What we claim is:

1. A heat-developable color light-sensitive material comprising light-sensitive silver halide grains, a binder, at least one compound represented by formula (I), and at least one dye-providing compound represented by formula (H), on a support,
wherein at least one of layers containing the light-sensitive silver halide grains contains the binder, the compound of formula (I), and the dye-providing compound of formula (II), at the same time, and
wherein the heat-developable color light-sensitive material contains no compound that participates in a coupling reaction with an oxidized product of the compound of formula (I): 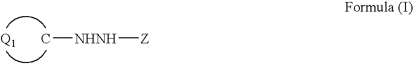
wherein, in formula (I), Z represents a carbamoyl group, an acyl group, an alkoxycarbonyl group, an aryloxycarbonyl group, a sulfonyl group, or a sulfamoyl group; and Q₁ represents a group of atoms necessary to form an unsaturated ring together with the carbon atom that bonds with —NHNH-Z;
Formula (II) 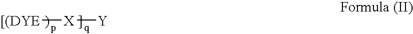
wherein, in formula (II), DYE represents a dye group or a dye precursor group; Y represents a group that makes a difference for the diffusibility of the dye component corresponding to the reduction of the light-sensitive silver halide having an image-wise latent image to silver; X represents a simple bond or a connecting group; p denotes a natural number of 1 or more, and q denotes 1 or 2, where DYEs may be the same or different when p is 2 or more and [(DYE)ₚ-X]s may be the same or different when q is 2.

2. The heat-developable color light-sensitive material as claimed in claim 1,
which contains a basic metal compound that is scarcely soluble in water, and
which forms an image by a reaction with an image-receiving material,
wherein the image-receiving material contains a mordant, and a compound that is capable of forming a complex with a metal ion constituting the basic metal compound in the presence of water in an amount of 1/10 to 1 times the amount necessary to give a fully swollen heat-developable color light-sensitive material, and
wherein, in the reaction, the heat-developable color-light-sensitive material and the image-receiving material are overlapped on each other, and heated in the overlapped state at a film surface temperature of from 50° C. to 100° C., for from 1 second to 120 seconds, to form or release a diffusible dye, and the diffusible dye is then diffused to the image-receiving material, to react with the mordant.

3. The heat-developable color light-sensitive material as claimed in claim 1, wherein the oxidized product of the compound of formula (I) is a dye having yellow to magenta color.

4. The heat-developable color light-sensitive material as claimed in claim 1, wherein Z represents a carbamoyl group.

5. The heat-developable color light-sensitive material as claimed in claim 1, wherein Z represents a carbamoyl group having a hydrogen atom bonded on its nitrogen atom.

6. The heat-developable color light-sensitive material as claimed in claim 1, wherein the unsaturated ring formed by Q₁ and the carbon atom is preferably a 3 to 8-membered ring.

7. The heat-developable color light-sensitive material as claimed in claim 1, wherein the unsaturated ring formed by Q₁ and the carbon atom is a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring, or a thiophene ring.
